(19) United States
(12) Patent Application Publication
(10) Pub. No.: US 2014/0278536 A1
(43) Pub. Date: Sep. 18, 2014

(54) Mobile Healthcare Development, Communication, And Management

(71) Applicants: Dongxiao Zhang, Orinda, CA (US); Di Shan, Pleasanton, CA (US); Chen Peng, Pleasanton, CA (US); Yabin Lu, Pleasanton, CA (US)

(72) Inventors: Dongxiao Zhang, Orinda, CA (US); Di Shan, Pleasanton, CA (US); Chen Peng, Pleasanton, CA (US); Yabin Lu, Pleasanton, CA (US)

(73) Assignee: BlueJay Mobile-Health, Inc

(21) Appl. No.: 13/843,827

(22) Filed: Mar. 15, 2013

(51) Int. Cl. G06F 19/00

(52) U.S. Cl. CPC G06F 19/322; G06F 19/3418
USPC 705/3

(57) ABSTRACT

A computer implemented method and system provides a mobile application development platform (MADP) for dynamically creating a healthcare provider specific customizable composite mobile application (CCMA) and monitoring healthcare elements of a healthcare recipient using the CCMA. The MADP is accessible by a healthcare provider device and a healthcare recipient device via a network. The MADP stores multiple template objects, for example, sub-applications that perform tasks for monitoring the healthcare elements in an application management database (AMD). The MADP acquires a selection of one or more template objects and one or more dynamic content objects defined by a healthcare provider and dynamically creates the CCMA by integrating the selected template objects and dynamic content objects. The MADP stores the CCMA in the AMD. The CCMA facilitates communication between the healthcare provider device and the healthcare recipient device for monitoring the healthcare elements of the healthcare recipient.

### BACKGROUND

A healthcare provider, for example, a doctor, a physician, a caregiver, etc., often needs to provide instructions to his/her patient and monitor his/her patient's self care activities and results, particularly during the time between clinical visits of the patient. The healthcare provider also often requires updated medical related information from a patient under self care. For example, a physician may want a patient to record symptoms pertaining to an illness and present accurate and organized results to the physician in a real time manner or during clinical visits. Most physicians typically hand out different symptom logs, for example, forms, questionnaires, etc., for patients to record their symptoms, or hand out paper checklists of medical related issues pertaining to pre-clinical visits or post-visit follow-ups.

Since health symptoms vary among patients and since each physician has his/her own requirement for a patient's self care, a standard or pre-programmed mobile application will not meet the physician's requirements for the patient. Most mobile healthcare applications are generic in nature and directed towards the treatment of a particular health condition of a patient. Conventional application development platforms do not allow a physician to design, develop, test, and distribute a physician-specific mobile application that comprises a comprehensive list of symptom logs for monitoring a patient's health, reminders and self care procedures and/or checkers of specific self care activities that the physician needs to check for compliance, and a feedback functionality that sends the patient's self care results, health status, and compliance to the physician.

Conventional application development platforms that assist a user, for example, a physician in developing a mobile application for a patient are not customized for the patient. Furthermore, conventional application development platforms generate symptom logs pertaining to a particular health condition of a patient that are not physician-specific and are not customized by the physician's instructions and inputs. Moreover, symptom logs generated by conventional application development platforms are mostly single symptom logs, have a rigid patient interface, and do not provide a physician interface and a real time, dynamically interacting patient interface. Furthermore, conventional application development platforms do not facilitate downloading a mobile application comprising a comprehensive list of symptom logs, for example, forms, questionnaires, etc., medical instructions, self care procedures and/or checkers, and demonstrational media content such that patients can select appropriate symptom logs, instructions, self care procedures and/or checkers, and demonstrational media content, and record symptoms using an electronic device.

Furthermore, creating symptom logs for every symptom of multiple diseases and developing self care instructions for every self care procedure for various medical examinations or clinical visits by a physician would be time consuming. Self care procedures and/or checkers and health related mobile demonstrational applications, for example, demonstrational media content are typically designed for the purpose of a single task or demonstration. Furthermore, conventional application development platforms do not provide open source content assistance, for example, sub-applications that other users have already designed and tested for physicians developing their own patient specific healthcare based mobile application. Furthermore, conventional application development platforms do not provide a comprehensive and diverse list of sub-applications that physicians and patients can pick and choose to enable customization of a mobile application for their healthcare requirements.

Hence, there is a long felt but unresolved need for a computer implemented method and a computer implemented system that provide a mobile application development platform that assists a healthcare provider in designing, developing, testing, and distributing a healthcare provider specific mobile application customized by the healthcare provider's instructions and inputs. Moreover, there is a need for a healthcare provider specific mobile application customized with a comprehensive list of symptom logs, reminders and self care procedures and/or checkers of specific self care activities, and a feedback functionality that sends a healthcare recipient's self care results, health status, medication compliance, etc., to the healthcare provider. Furthermore, there is a need for a computer implemented method and system that enables a healthcare provider to develop a mobile application customized for a healthcare recipient and supported, for example, by an open source multiple symptom log collection from which healthcare recipients can pick and choose to use a customized combination of symptom logs to record health status, by open source self care procedures and/or checkers from which healthcare providers and healthcare recipients can pick and choose combinations of self care procedures and/or checkers to assure compliance, and by open source multiple demonstrational media content that allows healthcare providers and healthcare recipients to pick and choose combinations of demonstrational media content.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated needs for providing a mobile application development platform that assists a healthcare provider in designing, developing, testing, and distributing a healthcare provider specific mobile application customized by the healthcare provider's instructions and inputs. As used herein, the term “healthcare provider” refers to a person or an entity, for example, a medical practitioner, a medical specialist, a health specialist, a physician, a doctor, a dentist, a surgeon, a nurse, a therapist, a nutritionist, a pharmacist, a clinical trial professional, a clinical study professional, a health insurance company, a health maintenance organization, a financial institution, a caregiver, etc., that provides healthcare services, for example, medical treatment, medication, dental treatment, health insurance, etc., to a healthcare recipient. Also, as used herein, the term “healthcare recipient” refers to a person or an entity, for example, a patient who receives healthcare services from a healthcare provider. The computer implemented method and system disclosed herein also address the above stated need for a healthcare provider specific mobile application customized with a comprehensive list of symptom logs, reminders and self care procedures and/or checkers of specific self care activities, and a feedback functionality that sends the healthcare recipient's self care results, health status, medication compliance, etc., to the healthcare provider. The computer implemented method and system disclosed herein enables a healthcare provider to develop a mobile application customized for a healthcare recipient and supported, for example, by an open source multiple symptom log collection from which healthcare recipients can pick and choose to use a customized combination of symptom logs to record health status, by open source self care procedures and/or checkers from which healthcare providers and healthcare recipients can pick and choose combinations of self care procedures and/or checkers to assure compliance, and by open source demonstrational media content that allows healthcare providers and healthcare recipients to pick and choose combinations of demonstrational media content.

The computer implemented method and system disclosed herein provides a mobile application development platform (MADP) for dynamically creating a healthcare provider specific customizable composite mobile application and monitoring healthcare elements of a healthcare recipient, for example, a patient using the customizable composite mobile application (CCMA). As used herein, the term “healthcare element” refers to an item of healthcare associated with a healthcare recipient, which can be tracked and monitored by a healthcare provider. The healthcare elements comprise, for example, symptoms, physiological parameters such as heart rate, blood pressure, blood sugar, etc., medication compliance, healthcare compliance, pre-visit preparations of the healthcare recipient, and post visit follow ups of the healthcare recipient, healthcare activities such as exercises performed by the healthcare recipient, etc. The term “compliance” refers to a degree of adherence by a healthcare recipient, for example, to instructions, inputs, and healthcare advice provided by a healthcare provider. For example, a healthcare provider can monitor medication or drug compliance, usage of medical devices, self care, self-directed exercises, therapy sessions, etc., using the CCMA. The MADP comprises at least one processor configured to facilitate dynamic creation of the CCMA. The MADP is accessible by a healthcare provider device and a healthcare recipient device via a network. As used herein, the term “healthcare provider device” refers to an electronic device utilized by a healthcare provider for accessing and communicating with the MADP and the CCMA via a network. Also, as used herein, the term “healthcare recipient device” refers to an electronic device utilized by a healthcare recipient for accessing and communicating with the MADP via a network for utilizing the healthcare provider specific CCMA.

The mobile application development platform (MADP) stores multiple template objects in an application management database. As used herein, the term “template object” refers to a template, an application, or a common format that defines tasks or functions to be performed. The template objects comprise multiple sub-applications configured to perform tasks for monitoring the healthcare elements of the healthcare recipient. As used herein, the term “sub-application” refers to a software application configured to perform a particular task. One or more sub-applications constitute the customizable composite mobile application (CCMA). The tasks for monitoring the healthcare elements of the healthcare recipient performed by the sub-applications comprise, for example, generating one or more symptom logs for each of multiple health conditions of the healthcare recipient, generating medication reminders configured to manage and record administration of medications by the healthcare recipient, generating appointment reminders configured to manage clinical visits of the healthcare recipient, generating instructions for a pre-clinic visit and a post-clinic visit for the healthcare recipient, and generating demonstrational media content configured to show therapeutical activities for managing the health conditions of the healthcare recipient. The template objects further comprise format templates configured, for example, for questions, answers, instructions, reports, data analysis, and summarization of results associated with the healthcare elements of the healthcare recipient. In an embodiment, a service administrator of the MADP defines and stores the template objects in the application management database. In another embodiment, the MADP retrieves the template objects from multiple sources. For example, the MADP retrieves the template objects such as questionnaires, medical procedures, etc., from publicly available sources via the network. In another example, the MADP retrieves the template objects from prior content and formats of sub-applications that was created and stored in the application management database as editable content.

A healthcare provider defines or customizes and provides dynamic content objects from a healthcare provider device to the mobile application development platform (MADP) via a graphical user interface (GUI) provided by the MADP. As used herein, the term “dynamic content object” refers to an item of dynamic content, for example, textual content, video content, audio content, content in applications such as rich internet applications, etc., or any combination thereof, that changes or can be varied in time. The dynamic content objects comprise contents and functionalities specialized and provided by the healthcare provider based on the needs of the healthcare provider. The dynamic content objects comprise, for example, a symptom log type, a questionnaire type, content of questions, content of answers, presentation formats, presentation content, healthcare provider specific information, instructions from the healthcare provider, display preferences of the healthcare provider, and any combination thereof. The MADP acquires one or more dynamic content objects defined by the healthcare provider, for example, a physician via the GUI provided by the MADP. The dynamic content objects are typically stored temporarily or embodied, for example, in data files, the application management database, records, etc. The MADP acquires a selection of one or more of the template objects and the acquired dynamic content objects from the healthcare provider device via the GUI based on instructions provided by the healthcare provider. The selection of the template objects comprises a selection of one or more of content for each of the sub-applications configured to execute the tasks on the healthcare recipient device and a format template for each of the sub-applications. In an embodiment, the MADP stores the acquired dynamic content objects in the application management database.

The mobile application development platform (MADP) dynamically creates a customizable composite mobile application (CCMA) by integrating one or more of the template objects and the acquired dynamic content objects based on the acquired selection. The MADP is configured to store the dynamically created CCMA in the application management database. In an embodiment, the dynamically created CCMA is configured as a software application downloadable on the healthcare recipient device. The application management database is accessible by the healthcare recipient device via the network for utilization of the dynamically created CCMA. The MADP facilitates communication between the healthcare provider device and the healthcare recipient device through the dynamically created CCMA via the application management database and the network for monitoring the healthcare elements of the healthcare recipient.

The dynamically created customizable composite mobile application (CCMA) renders the selected template objects and the acquired dynamic content objects to the healthcare recipient via one or more of multiple communication modes. The communication modes comprise, for example, a voice mode, a text mode, an image mode, an audio mode, a video mode, a multimedia mode, etc., and any combination thereof. The CCMA records responses to the selected template objects and the acquired dynamic content objects from the healthcare recipient via one or more of multiple communication modes comprising, for example, a voice mode, a text mode, an image mode, an audio mode, a video mode, a multimedia mode, etc., and any combination thereof. The mobile application development platform (MADP) dynamically updates the template objects in the application management database based on improvement criteria and changes acquired from one or more healthcare provider devices and one or more healthcare recipient devices via the network. The dynamically created CCMA summarizes results generated by each of the sub-applications onto one or more display interfaces for interconnecting one or more of the sub-applications. The display interfaces comprise, for example, a calendar interface, a report interface, etc.

A healthcare recipient can download the dynamically created customizable composite mobile application (CCMA) on the healthcare recipient device from the application management database via the network. The mobile application development platform (MADP) acquires healthcare recipient data comprising, for example, a selection of one or more of the sub-applications from the selected template objects via the GUI for customizing the dynamically created CCMA. In an embodiment, the MADP acquires healthcare recipient data comprising, for example, a selection of one or more of content for each of the sub-applications and a format template for each of the sub-applications. The healthcare recipient data comprises, for example, one or more of textual data, voice data, image data, audio data, video data, multimedia data, etc., and any combination thereof. The MADP updates the dynamically created CCMA based on the acquired healthcare recipient data. The MADP delivers the updated dynamically created CCMA to the healthcare recipient device via the application management database and the network. In an embodiment, the MADP transmits notifications to the healthcare recipient device via the network. The notifications comprise, for example, instructions defined by the healthcare provider via the GUI of the MADP based on the acquired healthcare recipient data. In another embodiment, the MADP generates reports based on changes in the template objects.

The computer implemented method and system disclosed herein facilitates and strengthens a healthcare provider's care by enhanced monitoring of a healthcare recipient's symptom progress, timely gathering of additional detailed healthcare information, increased supervision on healthcare compliance, and extension, explanation, and enrichment of the healthcare provider's instructions. In an embodiment, the dynamically created customizable composite mobile application (CCMA) is configured as an open source, combination of mobile sub-applications designed and contributed by healthcare providers, with a goal to provide a complete symptom recording and self care management tool for healthcare recipients to self-monitor, self-record, and self-manage health status. The CCMA provides an accurate description of the healthcare recipients' health status to their healthcare providers.

Because the computer implemented method and system disclosed herein provides sub-application content that has been contributed by previous physicians, designers, and other healthcare providers, the application management database grows with time and allows the sub-applications to be borrowed and edited by new application designers and healthcare providers. The dynamically created customizable composite mobile application (CCMA) can contain many sub-applications that other designers and healthcare providers have already designed and tested. The CCMA therefore contains a comprehensive list of sub-applications that the healthcare provider and the healthcare recipient can pick and choose to their own use. The CCMA may contain diverse sub-applications comprising, for example, a large list of symptom logs, reminder and/or checker applications of medication, reminder and/or checker applications of pre-visit preparations such as medical exams, procedures, etc., reminder and/or checker applications of post-visit follow-ups, video demonstrational collections such as a suite of physical therapy demos for healthcare recipients to pick and choose according to specific needs, other announcements from the owner healthcare provider and others, etc. Although some healthcare providers may choose to develop and use a single sub-application, for example, a symptom log of headache for dynamically creating the CCMA, most healthcare providers may effectively customize the CCMA for a specific healthcare recipient, for example, by picking and choosing certain symptom logs and reminders for each healthcare recipient. The computer implemented method and system disclosed herein therefore enables individual healthcare providers to develop a CCMA that contains a large number of sub-applications which address diverse healthcare needs, enables healthcare recipients to customize their healthcare provider's CCMA, and also enables the healthcare providers and the healthcare recipients to communicate the results.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for dynamically creating a healthcare provider specific customizable composite mobile application and monitoring healthcare elements of a healthcare recipient using the customizable composite mobile application.

FIG. 2 illustrates a block diagram showing the steps for dynamically creating a healthcare provider specific customizable composite mobile application through a mobile application development platform.

FIG. 3 exemplarily illustrates a process flow diagram comprising the steps for defining and storing template objects in an application management database.

FIGS. 4A-4B exemplarily illustrate a process flow diagram comprising the steps for creating a healthcare provider specific customizable composite mobile application.

FIGS. 5A-5B exemplarily illustrate a process flow diagram comprising the steps for utilization of the dynamically created customizable composite mobile application via the application management database by a healthcare recipient for execution of tasks.

FIGS. 6A-6B exemplarily illustrate a process flow diagram comprising the steps performed by the mobile application development platform for facilitating communication between a healthcare provider device and a healthcare recipient device through the dynamically created customizable composite mobile application.

FIG. 7 exemplarily illustrates a flowchart comprising the steps for executing tasks for monitoring healthcare elements of a healthcare recipient using the dynamically created customizable composite mobile application.

FIGS. 8A-8O exemplarily illustrate screenshots of a graphical user interface displaying multiple sub-applications configured to perform tasks for monitoring healthcare elements of a healthcare recipient.

FIG. 9 exemplarily illustrates a screenshot of a graphical user interface provided by the mobile application development platform for dynamically creating the healthcare provider specific customizable composite mobile application.

FIGS. 10A-10H exemplarily illustrate screenshots of a graphical user interface provided by the mobile application development platform, displaying format templates for different question types.

FIGS. 11A-11B exemplarily illustrate screenshots of a graphical user interface provided by the mobile application development platform, displaying format templates for different answer types.

FIG. 12 exemplarily illustrates a screenshot of a graphical user interface provided by the mobile application development platform, displaying a format template for generating reports associated with healthcare elements of a healthcare recipient.

FIGS. 13A-13E exemplarily illustrate screenshots of a graphical user interface provided by the mobile application development platform, displaying multiple report formats used in generation of reports associated with healthcare elements of a healthcare recipient.

FIGS. 14A-14C exemplarily illustrate screenshots of a graphical user interface provided by the mobile application development platform, for generating reminders and instructions for a pre-clinic visit and a post-clinic visit.

FIG. 15 exemplarily illustrates a screenshot of a graphical user interface provided by the mobile application development platform for patients.

FIG. 16 exemplarily illustrates a computer implemented system for dynamically creating a healthcare provider specific customizable composite mobile application and monitoring healthcare elements of a healthcare recipient using the customizable composite mobile application.

FIG. 17 exemplarily illustrates the architecture of a computer system employed by the mobile application development platform and a healthcare recipient device for dynamically creating a healthcare provider specific customizable composite mobile application and monitoring healthcare elements of a healthcare recipient using the customizable composite mobile application.

FIG. 18 exemplarily illustrates a network architecture employed by the mobile application development platform for dynamically creating a healthcare provider specific customizable composite mobile application and monitoring healthcare elements of a healthcare recipient using the customizable composite mobile application.

FIG. 19 exemplarily illustrates a software architecture employed by the mobile application development platform for dynamically creating a healthcare provider specific customizable composite mobile application and monitoring healthcare elements of a healthcare recipient using the customizable composite mobile application.

### DETAILED DESCRIPTION OF THE INVENTION

FIG. 1 illustrates a computer implemented method for dynamically creating a healthcare provider specific customizable composite mobile application and monitoring healthcare elements of a healthcare recipient using the customizable composite mobile application (CCMA). As used herein, the term “healthcare provider” refers to a person or an entity, for example, a medical practitioner, a medical specialist, a health specialist, a physician, a doctor, a dentist, a surgeon, a nurse, a therapist, a nutritionist, a pharmacist, a clinical trial professional, a clinical study professional, a health insurance company, a health maintenance organization, a financial institution, a caregiver, etc., that provides healthcare services, for example, medical treatment, medication, dental treatment, health insurance, etc., to a healthcare recipient. Also, as used herein, the term “healthcare recipient” refers to a person or an entity, for example, a patient who receives healthcare services from a healthcare provider. Also, as used herein, the term “healthcare element” refers to an item of healthcare associated with a healthcare recipient, which can be tracked and monitored by a healthcare provider. The healthcare elements comprise, for example, symptoms, physiological parameters such as heart rate, blood pressure (BP), blood sugar, etc., medication compliance, healthcare compliance, pre-visit preparations of the healthcare recipient, post visit follow ups of the healthcare recipient, healthcare activities such as exercises performed by the healthcare recipient, etc. The term “compliance” refers to a degree of adherence by a healthcare recipient, for example, to instructions, inputs, and healthcare advice provided by a healthcare provider. For example, a healthcare provider can monitor medication or drug compliance, usage of medical devices, self care, self-directed exercises, therapy sessions, etc., using the CCMA.

The computer implemented method disclosed herein provides 101 a mobile application development platform (MADP) comprising at least one processor configured to facilitate the dynamic creation of the customizable composite mobile application (CCMA). The MADP is accessible by a healthcare provider device and a healthcare recipient device via a network. As used herein, the term “healthcare provider device” refers to an electronic device utilized by a healthcare provider for accessing and communicating with the MADP and the CCMA via a network. Also, as used herein, the term “healthcare recipient device” refers to an electronic device utilized by a healthcare recipient for accessing and communicating with the MADP via a network for utilizing the healthcare provider specific CCMA. Examples of the healthcare provider device and the healthcare recipient device comprise a personal computer, a tablet computing device, a mobile computer, a mobile phone, a smart phone, a portable computing device, a laptop, a personal digital assistant, a touch centric device, a workstation, a client device, a portable electronic device, a network enabled computing device, an interactive network enabled communication device, any other suitable computing equipment, and combinations of multiple pieces of computing equipment, etc. The network is, for example, a wired network, a wireless network, a network that implements WiFi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area communication network, an internet connection network, an infrared communication network, etc., or a network formed from a combination of these networks.

The mobile application development platform (MADP) stores 102 multiple template objects in an application management database. As used herein, the term “template object” refers to a template, an application, or a common format that defines tasks or functions to be performed. In an embodiment, a service administrator of the MADP defines and stores the template objects in the application management database. In another embodiment, the MADP retrieves the template objects from multiple sources. For example, the MADP retrieves the template objects such as questionnaires, medical procedures, etc., from publicly available sources via the network. In another example, the MADP retrieves the template objects from prior content and formats of sub-applications created and stored in the application management database as editable content. The template objects comprise, for example, format templates and mobile application libraries. The format templates are configured, for example, for questions, answers, instructions, reports, data analysis, and summarization of results associated with the healthcare elements of the healthcare recipient. Each of the mobile application libraries comprises a collection of subprograms or sub-applications used to develop the customizable composite mobile application (CCMA). The mobile application libraries comprise multiple sub-applications configured to perform tasks for monitoring healthcare elements of the healthcare recipient. As used herein, the term “sub-application” refers to a software application configured to perform a particular task. One or more sub-applications constitute the CCMA.

The mobile application libraries comprise, for example, a core mobile application library (CMAL) configured by previous healthcare providers, designers, etc., from an open source environment, a dynamic mobile application library (DMAL) configured by individual healthcare providers, etc. The CMAL contains previously configured open source sub-applications that can be selected and utilized by a healthcare provider, as no single healthcare provider has the time and knowledge to write content, for example, symptom logs for a large number of diseases. Each of the sub-applications in the DMAL is a software application configured by individual healthcare providers. The DMAL is deployed as a single application on the healthcare recipient device. The CCMA comprises multiple interconnected sub-applications of the DMAL, where each sub-application performs a single task. The tasks for monitoring the healthcare elements of the healthcare recipient performed by the sub-applications comprise, for example, generating one or more symptom logs such as a symptom log for pain for each of multiple health conditions of the healthcare recipient, generating medication reminders configured to manage and record administration of medications by the healthcare recipient, generating appointment reminders configured to manage clinical visits of the healthcare recipient, generating instructions for a pre-clinic visit and a post-clinic visit for the healthcare recipient, and generating demonstrational media content such as a video demonstration for neck pain management configured to show therapeutical activities for managing the health conditions of the healthcare recipient. As used herein, the term “demonstrational media content” refers to multi-media demonstration clips containing a picture or a video demonstration pertaining to health related tasks. The mobile application development platform (MADP) enables healthcare providers to configure their own CCMA or individual healthcare provider specific sub-applications using the template objects. Within each sub-application, the MADP facilitates development of multimedia communication functions for transmitting information back to the healthcare provider and for receiving new instructions.

The customizable composite mobile application (CCMA) contains sub-applications for generating, for example, a list of symptom logs, medication reminders and/or checkers, visit reminders, specialized instructions and checkers for pre-clinic visits and post-clinic visits, instructional applications in multimedia form, etc. The sub-applications of the CCMA comprise, for example, a log generation sub-application, a reminder generation sub-application, an instruction generation sub-application, and a content generation sub-application as exemplarily illustrated in FIG. 16. The log generation sub-application is configured to manage a symptom log. The reminder generation sub-application reminds, manages, and records the administration of medication by a healthcare recipient. The reminder sub-application further reminds and manages the clinical visits of the healthcare recipient. The instruction generation sub-application manages instructions and self care procedures and/or checkers, for example, medical exams, procedures, etc., to be carried out prior to a clinical visit. In an example, the reminders and self care procedures and/or checkers generated by the instruction generation sub-application for a colonoscopy preparation reminds a healthcare recipient to record fluid intake and fast before the colonoscopy procedure with the time for fluid intake and fast being set based on the date and time for carrying out the colonoscopy procedure. The instruction generation sub-application transmits the compliance status to the healthcare provider device before the colonoscopy procedure. In another example, the instruction generation sub-application generates post-surgery or post-clinic visit instructions related, for example, to self care activities such as changing a bandage, for the healthcare recipient.

The content generation sub-application generates demonstrational media content, for example, video demonstration clips, with each video demonstration clip showing a physical therapy exercise for managing specific anatomical pain. The healthcare recipient can select a combination of demonstrational media content and follow them to exercise. In an embodiment, the CCMA further contains a drug to drug and/or food interaction search engine to enable healthcare recipients to check how to use a particular medication or a particular drug. In an embodiment, the CCMA comprises healthcare provider information, for example, a doctor's logo, a doctor's photograph, etc. In an embodiment, the CCMA and the healthcare provider information are downloadable from a healthcare provider specific webpage hosted by the mobile application development platform (MADP).

A healthcare provider defines and provides dynamic content objects to the mobile application development platform (MADP) via a graphical user interface (GUI) provided by the MADP. The MADP acquires 103 one or more dynamic content objects defined by the healthcare provider via the GUI provided by the MADP. As used herein, the term “dynamic content object” refers to an item of dynamic content, for example, textual content, video content, audio content, content in applications such as rich internet applications, etc., or any combination thereof, that changes or can be varied in time. The dynamic content objects comprise contents and functionalities specialized and provided by the healthcare provider. The dynamic content objects comprise, for example, a selected symptom log type, a selected questionnaire type, content of questions, content of answers, presentation formats, presentation content, healthcare provider specific information, instructions from the healthcare provider, display preferences of the healthcare provider, etc., and any combination thereof. In an embodiment, the MADP stores the acquired dynamic content objects in the application management database. In an embodiment, the application management database that stores the template objects and the dynamic content objects is configured as a cloud based database implemented in a cloud computing environment, where computing resources are delivered as a service over a network, for example, the internet.

A healthcare provider can select one or more of the template objects and the acquired dynamic content objects via the GUI provided by the mobile application development platform (MADP). The MADP acquires 104 a selection of one or more of the template objects and the acquired dynamic content objects from the healthcare provider device via the GUI. A selection of one or more of the template objects comprises a selection of one or more of content for each of the sub-applications configured to execute tasks on the healthcare recipient device and a format template for each of the sub-applications. The MADP dynamically creates 105 the customizable composite mobile application (CCMA) by integrating the template objects and the acquired dynamic content objects selected by the healthcare provider. In an embodiment, the MADP stores 106 the dynamically created CCMA in the application management database. The application management database is accessible by the healthcare recipient device via the network for utilization of the dynamically created customizable composite mobile application.

The MADP facilitates 107 communication between the healthcare provider device and the healthcare recipient device through the dynamically created customizable composite mobile application (CCMA) via the application management database and the network for monitoring the healthcare elements of the healthcare recipient. Healthcare providers such as doctors and healthcare recipients such as patients can communicate with each other through the application management database and their respective electronic devices. For example, patients can send reports and data to a doctor and receive feedback from the doctor through the dynamically created CCMA via the application management database. Information such as reports, data, feedback, compliance status, etc., is transmitted between the healthcare provider device and the healthcare recipient device back and forth via the application management database. That is, both the healthcare provider and the healthcare recipient access the information through the application management database via the network. The healthcare provider via the MADP, for example, sets reminders and self care procedures and/or checkers for healthcare recipients to prepare for a clinical procedure or visit, to check compliance, and to decide whether the healthcare recipient's preparation is sufficient prior to a clinical visit for a medical procedure. The dynamically created CCMA summarizes results generated by each of the sub-applications onto one or more display interfaces for interconnecting one or more sub-applications. The display interfaces comprise, for example, a calendar interface, a report interface, etc.

The dynamically created customizable composite mobile application (CCMA) is configured as a software application downloadable on the healthcare recipient device. The healthcare recipient downloads the dynamically created CCMA on the healthcare recipient device from the application management database via the network. On downloading the dynamically created CCMA on the healthcare recipient device, the CCMA renders the template objects and the acquired dynamic content objects selected by the healthcare provider to the healthcare recipient device via one or more of multiple communication modes, for example, a voice mode, a text mode, an image mode, an audio mode, a video mode, a multimedia mode, etc., and any combination thereof. For example, the CCMA reads out questionnaires in a voice mode to healthcare recipients. The CCMA records responses to the selected template objects and the acquired dynamic content objects from the healthcare recipient via one or more of the communication modes. For example, the healthcare recipient can choose to input records by text, voice, pictures, etc., or any combination thereof. The recorded responses and healthcare recipient data, for example, summaries, results, reports, etc., are stored in the healthcare recipient device and uploaded to the application management database via the network. The CCMA may also transmit the recorded responses and the healthcare recipient data to the healthcare provider device via the network. In an embodiment, the healthcare recipient accesses the dynamically created CCMA, for example, on a web based platform via the network.

In an embodiment, the mobile application development platform (MADP) acquires healthcare recipient data comprising a selection of one or more sub-applications from the selected template objects via a graphical user interface (GUI) provided by the dynamically created CCMA for customizing the dynamically created CCMA. For example, the MADP allows a healthcare recipient such as a patient to select sub-applications by picking and choosing individual sub-applications such as different symptom logs from the application management database. In an embodiment, the MADP acquires healthcare recipient data comprising, for example, a selection of one or more of content for each of the sub-applications and a format template for each of the sub-applications. The healthcare recipient data comprises, for example, one or more textual data, voice data, image data, audio data, video data, multimedia data, and any combination thereof. The MADP updates the dynamically created CCMA based on the acquired healthcare recipient data and delivers the updated dynamically created CCMA to the healthcare recipient device via the application management database and the network. In an embodiment, the MADP transmits notifications to the healthcare recipient device via the network. The notifications comprise, for example, instructions defined by the healthcare provider via the GUI of the MADP based on the acquired healthcare recipient data.

The mobile application development platform (MADP) dynamically updates the template objects in the application management database based on improvement criteria and changes acquired from one or more healthcare provider devices and one or more healthcare recipient devices via the network. The improvement criteria can be set, for example, based on usage and popularity of a sub-application. For example, the MADP incorporates a sub-application with a higher score into the core mobile application library (CMAL), and phases out a sub-application with a lower score. In an embodiment, the MADP generates reports based on changes in the template objects. The MADP is configured to automatically manage and organize the development of the dynamically created customizable composite mobile application (CCMA), the communications between the healthcare provider devices and the healthcare recipient devices, and the application management database to implement a growing and dynamic system with a core mobile application library (CMAL) and as a result, the CCMA learns, expands, and improves with time based on incorporation of mobile applications contributed by other healthcare providers or designers that can be borrowed and edited by any current application designer. The healthcare provider and the healthcare recipient can customize and update content of the CCMA, for example, by setting reminders, checking compliance through checkers, etc., on the healthcare recipient device.

In an embodiment, the mobile application development platform (MADP) is configured as a web based platform for creating a healthcare provider specific customizable composite mobile application (CCMA), for example, a doctor initiated self care CCMA using template objects and dynamic content objects. The MADP enables the healthcare provider to create the CCMA comprising self-designed sub-applications for healthcare recipients that assists the healthcare recipients in managing their self care needs according to healthcare provider instructions. In another embodiment, the MADP is configured as a multiplexed mobile application management system. The multiplicity of the MADP is reflected as follows: The MADP incorporates multiple sub-applications for different functional tasks under a single customizable composite mobile application. The MADP enables multiple healthcare providers to generate and differentiate sub-applications that perform the same or similar functional tasks. For example, if different doctors configure different sub-applications for an asthma log, the MADP selects or combines the most used sub-applications and incorporates the selected or combined sub-applications into the core mobile application library. The MADP enables each healthcare provider to create and own multiple sub-applications that can be selected and used by multiple healthcare recipients. The MADP enables a healthcare recipient to select and use sub-applications from multiple healthcare providers. A sub-application created by a healthcare provider can be edited, enriched, and owned by multiple healthcare providers at a later point in time. If the healthcare recipients require different CCMAs with different dynamic mobile application libraries configured by different healthcare providers for different health conditions, the MADP provides an application wrapper containing different dynamic mobile application libraries configured by different healthcare providers to access self care activities and content from different healthcare providers. The application wrapper containing the different dynamic mobile application libraries are represented by a single application icon displayed on an interface of the healthcare recipient device.

The computer implemented method and the computer implemented system disclosed herein enable the mobile application development platform (MADP) to create and distribute the customizable composite mobile application (CCMA). The CCMA configured by a healthcare provider assists in patient self care activities comprising, for example, symptom recording, medication management, task tracking, multimedia demonstration of health tasks, etc. For each CCMA created by the healthcare provider, the MADP provides multiple choices in user rights to the healthcare provider for the usage and distribution of the CCMA configured by the healthcare provider. For example, the MADP allows a healthcare provider to deposit the CCMA in the application management database. If the healthcare provider chooses this option, then the healthcare provider would only own a copyright of the CCMA and not own the commercial rights to the CCMA. The healthcare provider and his/her healthcare recipients, for example, direct patients have the right to use the CCMA for a period of time or an entire lifetime. The MADP also provides a choice to the healthcare provider to co-own the commercial rights to the CCMA. If the healthcare provider chooses this option, then the MADP does not deposit the CCMA in the application management database, commercializes the CCMA on a website and public application stores, and shares the revenue with the healthcare provider. The MADP also provides the option of owning exclusive rights of the CCMA to the healthcare provider and his/her institution for non-commercial use, if the healthcare provider pays development fees to the MADP.

In an embodiment, the mobile application development platform (MADP) generates revenue, for example, by providing service contracts to hospitals, clinics or individual healthcare providers who register with the MADP. The service contract is initially free for all hospitals and healthcare providers, for example, physicians who develop customizable composite mobile applications (CCMAs) and store the CCMAs in the application management database. In another embodiment, the MADP generates revenue by charging service fees for exclusive application development. In another embodiment, the MADP generates revenue by selling the CCMA and individual or co-owned sub-applications. In another embodiment, the MADP generates revenue by allowing healthcare recipients, for example, patients to download and use the CCMA for a predetermined subscription fee. In another embodiment, the MADP generates revenue by providing advertisements to healthcare recipients via the CCMA.

The computer implemented method and system disclosed herein implements a business to business to consumer (B to B to C) business model, that is, the mobile application development platform (MADP) to healthcare provider to healthcare recipient model, centered in an open source environment with a growing and improving application management database configured to continually store a collection of customized and improved self care mobile applications that can be provided to healthcare providers and healthcare recipients in a customized manner. The MADP charges service fees or subscription fees for maintaining, using, and upgrading the application management database.

The computer implemented method and system disclosed herein implements multiple open source symptom logs. A patient or his/her physician can choose a subset of symptom logs to record symptoms. Such symptom logs can generate reports which are stored, for example, in mobile devices, the mobile application development platform (MADP), a server, and/or sent to healthcare providers. The collection of such symptom logs grows in an open source environment. New symptom logs from physicians, caregivers, and other healthcare providers are dynamically added to the collection, resulting in a growing application management database that includes more complete mobile logs of various symptoms.

The computer implemented method and system disclosed herein also implements multiple open source self care checkers. The self care checkers allow healthcare providers to check compliance, for example, healthcare compliance, medication compliance, etc., of healthcare recipients with instructions and advice provided by the healthcare providers. A patient or his/her physician can choose a subset of self care tasks to follow. The self care checkers contain both timed reminder functions, task checker functions, and accomplishment recording functions. The self care checkers can generate reports which are stored, for example, in the mobile application development platform (MADP), a server, and/or sent to healthcare providers. The collection of such self care checkers grows in an open source environment. New self care checkers designed by physicians, caregivers, and other healthcare providers are dynamically added to the collection, resulting in a growing application management database that includes more complete mobile task checkers of various self care needs.

The computer implemented method and system disclosed herein also implements multiple open source demonstrational content containing multiple multimedia clips for professional demonstration of self care tasks. A patient or his/her physician can choose a subset of demonstrational clips to learn about selected topics. Such demonstrational clips can be multimedia based. The collection of such demonstrational clips grows in an open source environment. New demonstrational clips from physicians, caregivers, and other healthcare providers are dynamically added to the collection, resulting in a growing application management database that includes more complete demonstrational clips on various health self care tasks.

In addition to symptom logging and monitoring of other healthcare elements by a doctor-patient setup via the mobile application development platform (MADP), in communication with the customizable composite mobile application (CCMA), the computer implemented method and system disclosed herein can be extended to include other types of users and applications, for example, a trainer-trainee setup for yoga classes, a researcher-subject setup in a clinical trial, and other health related topics. Furthermore, healthcare providers, for example, pharmacists can use the MADP to develop their own CCMAs for patients. Patients can remind themselves or family members to take medications using the reminder sub-application of the CCMA. During a pharmacy consultation, a pharmacist can use the CCMA to directly select a drug name, strength, number of times, and actual time for taking the medicine. The MADP inputs the information selected by the pharmacist to a web based patient account and synchronizes the information to the CCMA on the patient's electronic device. The sub-applications of the CCMA are also configured to provide related drug information, for example, drug-drug interaction and drug-food interactions, side effects, etc. The sub-applications of the CCMA can also be configured to set reminders for a refill of a medication. Furthermore, in another example, clinical trial professionals may request patients to download the CCMA that they developed using the MADP, and collect health status, symptoms, side effects, and other information associated with a clinical trial from the patients via the CCMA.

FIG. 2 illustrates a block diagram showing the steps for dynamically creating a healthcare provider specific customizable composite mobile application (CCMA) through a mobile application development platform (MADP). The MADP is configured to facilitate the dynamic creation of the CCMA. The MADP stores multiple template objects 205 in a central database, that is, the application management database 207. A service administrator 201 of the MADP defines and develops multiple template objects 205 comprising common format templates and a core mobile application library (CMAL). The template objects 205 may also be retrieved from the application management database 207. The template objects 205 are defined, for example, using a number of available question-answer types or formats for symptoms, questionnaires, instructions, answer recording, data analyzing, result summaries, reports, result or answer or information sharing or posting, reminders, calendars, multimedia content, user accounts, etc. The core mobile application library comprises multiple common sub-applications configured to perform tasks for monitoring healthcare elements. The core mobile application library serves as a set of commonly used content for self care activities, for example, for logging symptoms, invoking reminders, self care procedures and/or checkers for self care purposes, etc. A healthcare provider 202 can choose or edit the template objects 205 for creation of the CCMA via the graphical user interface (GUI) 203 provided by the MADP. The GUI 203 is, for example, a web interface, a mobile application interface, etc. The MADP dynamically updates the template objects 205 in an open source environment using inputs and sub-applications provided by other healthcare providers and other users.

A healthcare provider 202, for example, a doctor defines one or more dynamic content objects 204, for example, a symptom log type, a questionnaire type, content of questions, content of answers, presentation formats, presentation content, healthcare provider specific information, instructions from the healthcare provider 202, display preferences of the healthcare provider 202, etc., and any combination thereof through the GUI 203. The MADP also enables the healthcare provider 202 to define the mode of distributing the customizable composite mobile application (CCMA) to healthcare recipients 209. The MADP acquires one or more dynamic content objects 204 defined by the healthcare provider 202 via the GUI 203. The MADP provides a web software and/or mobile software to govern the GUI 203 for enabling the healthcare provider 202 to define the dynamic content objects 204.

The mobile application development platform (MADP) acquires a selection of one or more template objects 205 and the acquired dynamic content objects 204 from the healthcare provider device via the GUI 203. The MADP comprises a mobile application creation module 206 configured to dynamically create a customizable composite mobile application (CCMA) by integrating the selected template objects 205 and the acquired dynamic content objects 204, for example, using a dynamic object definition matrix method. The application management database 207 organizes the template objects 205 and the dynamic content objects 204 through the dynamic object definition matrix. The inputs to a dynamic object definition matrix are, for example, the questionnaire type, the format template for a report, etc., of the template objects 205 and the dynamically defined symptom log type, the questionnaire type, content of answers, images, etc., of the dynamic content objects 204 to generate an executable CCMA file. The MADP stores the created CCMA in the application management database 207. The MADP updates the dynamic content objects 204 defined by the healthcare provider 202 and the inputs to the template objects 205 from the service administrator 201 in real time to the dynamic mobile application library configured in the dynamically created CCMA. In an embodiment, the healthcare provider 202 only provides content such as symptom logs to create the CCMA. When the MADP completes creation of the CCMA, the healthcare provider 202 can further select a subset of sub-applications for individual patients. The healthcare provider 202 can download multiple sub-applications for the same symptom from the application management database 207 and compare them to select the most suitable sub-applications for the healthcare recipient 209. Different healthcare providers can also download multiple sub-applications for different symptoms for different needs by the same healthcare recipient 209.

The MADP provides a web software and/or a mobile software to govern the graphical user interface (GUI) of the customizable composite mobile application (CCMA) for enabling the healthcare recipient 209 to select, choose, download, and communicate with the healthcare provider 202 through the CCMA. The healthcare recipient 209 downloads the dynamically created CCMA on the healthcare recipient device 208 from the application management database 207 via a network. The dynamic object definition matrix with the help of a pre-created pass code associated with the healthcare recipient 209 transmits specific content and configuration pertaining to the CCMA to the healthcare recipient device 208. The generated executable CCMA file, the content, and the configuration pertaining to the CCMA constitutes the CCMA on the healthcare recipient device 208. The dynamically created CCMA renders or distributes the template objects 205 and the acquired dynamic content objects 204 to the healthcare recipient device 208 via one or more of multiple communication modes, for example, a voice mode, a text mode, an image mode, an audio mode, a video mode, a multimedia mode, etc., and any combination thereof. The CCMA records healthcare recipient data comprising, for example, responses to the template objects 205 and the acquired dynamic content objects 204 from the healthcare recipient 209 via one or more communication modes. The healthcare recipient data comprises, for example, one or more textual data, image data, audio data, video data, multimedia data, etc., and any combination thereof. The responses from the healthcare recipient 209 comprise, for example, symptoms, values of physiological parameters such as blood sugar, heart rate, blood pressure, answers to the healthcare provider's 202 questions, etc. The healthcare recipient device 208 transmits the recorded healthcare recipient data to the application management database 207 via a communication module 210 of the MADP. The healthcare recipient 209 can also query the application management database 207 and upload the healthcare recipient data to the application management database 207.

The MADP displays the transmitted healthcare recipient data on the GUI 203 to the healthcare provider 202. The mobile application development platform (MADP) enables the healthcare provider 202, for example, a doctor to develop the dynamic mobile application library for the customizable composite mobile application (CCMA) by first selecting or editing the content of the core mobile application library. The healthcare provider 202 then selects a format template for questions, for example, with a single choice option, multiple choice options, pain scale options, etc. The healthcare provider 202 then defines the content of questions, the content of answers, etc., and selects a format template, for example, a timeline chart, a bar chart, a pie chart, etc., for reports associated with the healthcare elements of the healthcare recipient 209. The service administrator 201 of the MADP supervises the automatic generation of the CCMA and conducts a quality control of the sub-applications that constitute the CCMA. The MADP distributes the CCMA comprising the sub-applications to the healthcare recipient device 208. After distribution of the CCMA to the healthcare recipient device 208, the MADP enables the healthcare provider 202 to instruct each healthcare recipient 209 to customize the CCMA by selecting or editing the sub-applications of the CCMA for monitoring the healthcare elements, for example, symptoms, physiological parameters, medication compliance, pre-visit preparations and post visit follow ups of the healthcare recipient 209, and healthcare activities performed by the healthcare recipient 209. The MADP enables the healthcare provider 202 to set up reminders and self care procedures and/or checkers for healthcare recipients 209 and monitors the results via the GUI 203.

The MADP expands and improves the core mobile application library by selecting specific sub-applications developed by the healthcare provider 202 and other application designers and incorporating them into the core mobile application library. The MADP dynamically updates the template objects 205, for example, the core mobile application library in the application management database 207 based on improvement criteria and changes acquired from one or more healthcare provider devices and one or more healthcare recipient devices 208. The core mobile application library is maintained in an open-source environment to increase the content quality and the scope of the core mobile application library. The mobile application development platform (MADP) defines mobile application distribution options, for example, through application stores such as Google Play™ of Google Inc., the App Store™ of Apple Inc., the Windows® Phone Store of Microsoft Corporation, etc., where the MADP deposits the sub-applications. In an embodiment, the healthcare provider 202 may also directly distribute the sub-applications to one or more healthcare recipients 209, for example, via electronic mail, websites, etc.

The mobile application development platform (MADP) facilitates communication between the healthcare provider device and the healthcare recipient device 208 through the communication module 210 configured for data upload, download, and transmission between the customizable composite mobile application (CCMA) on the healthcare recipient device 208 and the GUI 203 of the MADP. The communication module 210 sends reports associated with the healthcare elements to the healthcare recipient device 208 and the healthcare provider device. The application management database 207 organizes and stores the template objects 205, the dynamic content objects 204, the CCMA, and the reports associated with the healthcare elements that are communicated between the healthcare recipient 209 and the healthcare provider 202.

FIG. 3 exemplarily illustrates a process flow diagram comprising the steps for defining and storing template objects in the application management database 207. The mobile application development platform (MADP) stores multiple template objects in the application management database 207. The template objects comprise format templates and mobile application libraries, for example, the core mobile application library as disclosed in the detailed description of FIGS. 1-2. The format templates comprise, for example, different formats of questionnaires and types of answers. The formats of questionnaires comprise single choice questions, multiple choice questions, descriptions, questions that require a value entry, checkers, time or date selections, location on an image, a sliding scale, etc. The core mobile application library comprises multiple sub-applications, for example, an attention deficit hyperactivity disorder (ADHD) symptom log, an asthma assessment log, a blood pressure monitoring log, a congestive heart failure (CHF) monitoring log, a depression log, a diabetes blood sugar log, a gastrointestinal (GI) symptom log, a prostate symptom log, a sleep log, a vital sign log, a medication reminder, a clinical visit reminder, a physical therapy demonstration video clip configured for a specific task, etc.

A healthcare provider 202 selects or edits the template objects via the graphical user interface (GUI) 203 provided by the mobile application development platform (MADP). Consider an example where the healthcare provider 202 configures a template object by customizing a sub-application. As exemplarily illustrated in FIG. 3, the healthcare provider 202 adds 301 a new symptom, edits 302 a question format, defines 303 a new question, defines 304 a new answer, selects 305 questions using a report format, and chooses 306 a report format via the GUI 203. The MADP acquires the configuration of the template object from the healthcare provider 202 via the GUI 203, creates the customizable composite mobile application (CCMA) using the template object, and stores the created CCMA in the application management database 207.

The healthcare recipient 209 downloads the customizable composite mobile application (CCMA) on the healthcare recipient device 208 exemplarily illustrated in FIG. 2. Each of the sub-applications of the CCMA performs a specific task. The sub-applications of the CCMA gather healthcare recipient data such as symptom information, health status, etc., for example, through voice guided questionnaires. The CCMA records symptoms, for example, in a text mode, a voice mode, an image mode, etc. The CCMA generates reports, for example, in a portable document format (PDF), a voice format, image format, etc., and stores the generated reports on the healthcare recipient device 208. The CCMA also transmits the generated reports to the application management database 207 via the network. The mobile application development platform (MADP) transmits the summarized results and reports associated with the healthcare elements of the healthcare recipient 209, for example, in the form of a portable document format (PDF) file, a voice file, an image file, etc., to the healthcare provider device, for example, via electronic mail. The summarized results and reports are displayed on the healthcare recipient device 208 and the healthcare provider device via their respective graphical user interfaces or on the GUI 203 provided by the MADP.

FIGS. 4A-4B exemplarily illustrate a process flow diagram comprising the steps for creating a healthcare provider specific customizable composite mobile application (CCMA). The mobile application development platform (MADP) is configured to facilitate the dynamic creation of the CCMA as disclosed in the detailed description of FIGS. 1-2. As exemplarily illustrated in FIG. 4A, the healthcare provider 202, for example, a doctor accesses the MADP by logging into the MADP. The MADP stores multiple template objects comprising format templates and mobile application libraries in the application management database 207. To create the CCMA, the healthcare provider device retrieves a template list of template objects from the application management database 207 via the graphical user interface (GUI) 203 exemplarily illustrated in FIG. 2, and selects template objects, for example, a question template to define a question, an answer template to define answers, and a report template to define a report via the GUI 203. The MADP dynamically creates the CCMA by integrating the selected template objects and the dynamic content objects acquired from the healthcare provider device.

Consider an example where a healthcare provider 202, for example, a doctor, wishes to create a customizable composite mobile application (CCMA) comprising a log generation sub-application. As exemplarily illustrated in FIG. 4B, the healthcare provider 202, through the GUI 203, selects 401 template objects from common symptom template objects stored in the application management database 207 or adds 402 new symptoms, chooses 403 a question format or edits an existing question format, defines 404 a new question or edits an existing question, defines 405 answer choices for the questions, chooses 406 a report format, and selects 407 questions using the report format for creating the CCMA. The MADP creates the CCMA based on the healthcare provider's 202 selections and definitions, and stores the CCMA in the application management database 207.

FIGS. 5A-5B exemplarily illustrate a process flow diagram comprising the steps for utilization of the dynamically created customizable composite mobile application (CCMA) via the application management database 207 by a healthcare recipient 209 for execution of tasks. The mobile application development platform (MADP) is configured to facilitate the dynamic creation of the CCMA as disclosed in the detailed description of FIGS. 1-2. As exemplarily illustrated in FIG. 5A, the healthcare recipient 209, for example, a patient accesses the MADP via a network by logging into the MADP. The healthcare recipient 209 downloads the dynamically created CCMA on the healthcare recipient device 208 exemplarily illustrated in FIG. 2. In an example, the healthcare recipient 209 requests the MADP for a healthcare provider specific CCMA, for example, a doctor personalized mobile application through the healthcare recipient device 208 and downloads the healthcare provider specific CCMA to the healthcare recipient device 208 via the network. The healthcare recipient 209 may then log into the CCMA. The MADP enables the healthcare recipient 209 to customize the template objects of the CCMA by selecting and activating relevant sub-applications based on their needs. The CCMA acquires responses to the template objects and the dynamic content objects from the healthcare recipient 209 via multiple communication modes, for example, a voice mode, a text mode, an image mode, an audio mode, a video mode, a multimedia mode, etc., and any combination thereof. The CCMA generates summarized results and reports, for example, daily logs associated with the healthcare elements of the healthcare recipient 209 on the healthcare recipient device 208. The CCMA transmits or uploads the generated summarized results and reports to the application management database 207 for storage via the network. The healthcare provider 202 exemplarily illustrated in FIG. 2 and the healthcare recipient 209 can view the generated summarized results and the reports on their respective devices.

As exemplarily illustrated in FIG. 5B, the healthcare recipient 209, for example, a patient, through the graphical user interface (GUI) 203 exemplarily illustrated in FIG. 2 inputs 501 a healthcare provider identifier (ID), for example, a doctor ID to log into the healthcare provider specific customizable composite mobile application (CCMA) and downloads 502 the healthcare provider specific CCMA content on the healthcare recipient device 208. The healthcare recipient 209 can then, for example, log data, follow healthcare provider instructions for a pre-clinic visit and a post-clinic visit, follow medication reminders and appointment reminders 503, etc., using the CCMA. The CCMA records daily results or monitors status and uploads 504 the summarized results and reports on the status, etc., to the application management database 207 for an accurate diagnosis by the healthcare provider 202.

FIGS. 6A-6B exemplarily illustrate a process flow diagram comprising the steps performed by the mobile application development platform (MADP) for facilitating communication between a healthcare provider device and a healthcare recipient device 208 exemplarily illustrated in FIG. 2, through the dynamically created customizable composite mobile application (CCMA). A notification service 601 implemented by the application management database 207 of the MADP transmits notifications, for example, alerts on reports generated by the customizable composite mobile application (CCMA) on the healthcare recipient device 208, notifications on electronic mail reports sent by a healthcare recipient 209, healthcare recipient reports 603, etc., to the healthcare provider 202 via a network. The healthcare provider 202 may also query the application management database 207 for a healthcare recipient report 603. The healthcare recipient 209 may also send the healthcare recipient report 603 generated by the CCMA to the healthcare provider 202, for example, through electronic mail (email) 602 as exemplarily illustrated in FIG. 6B.

FIG. 7 exemplarily illustrates a flowchart comprising the steps for executing tasks for monitoring healthcare elements of a healthcare recipient 209 exemplarily illustrated in FIG. 2, using the dynamically created customizable composite mobile application (CCMA). The mobile application development platform (MADP) enables a healthcare provider 202, for example, a doctor to dynamically create the CCMA. The MADP enables the healthcare provider 202 to define instructions and/or checkers, for example, by adding 701 a new medication and defining 702 a task for a pre-clinic visit or a post-clinic visit on a task timeline, etc., via the graphical user interface (GUI) 203 exemplarily illustrated in FIG. 2, provided by the MADP. The healthcare provider 202 uploads 703 the inputs to a dynamic mobile application library stored in the application management database 207 exemplarily illustrated in FIG. 2. The MADP generates the CCMA based on the inputs provided by the healthcare provider 202. The healthcare recipient 209, for example, a patient downloads 704 the CCMA with the instructions and/or checkers from the application management database 207 via the network. The healthcare provider 202 and/or the healthcare recipient 209 sets appointment reminders by entering 705, for example, a date and a time for clinical visits. The CCMA reminds 706 the patient when the visit date and time is reached. If the appointment reminder is accepted 707 by the healthcare recipient 209, the healthcare provider 202 can view 708 the healthcare recipient status via the GUI 203. If the appointment reminder is not accepted 707 by the healthcare recipient 209, the communication module 210 exemplarily illustrated in FIG. 2 of the MADP sends 709 notifications to the clinic informing about rejection of the appointment reminder. The clinic then calls the healthcare recipient 209 to reschedule 710 the clinical visit, if needed.

Consider an example where a healthcare provider 202 is a pharmacist and a healthcare recipient 209 is a patient. The mobile application development platform (MADP) enables the pharmacist to dynamically create a customizable composite mobile application (CCMA). The pharmacist accesses the MADP by logging into the MADP via the network, for example, the internet. To create the CCMA, the pharmacist retrieves a template list of template objects comprising multiple sub-applications configured to perform tasks for monitoring the healthcare elements of the patient from the application management database 207 via the graphical user interface (GUI) 203 exemplarily illustrated in FIG. 2. The pharmacist selects template objects, for example, a question template to define a question, an answer template to define answers, etc., via the GUI 203. In an example, the pharmacist inputs a medicine input box such as a drop down selection of medicine and strength, a timer for creating a reminder of medicine administration, a check box for finishing the task, a drug-drug interaction warning based on backend searching of a public database, a display of key drug information based on linkage to a public database, and a web link to a public database to obtain additional drug information via the GUI 203. The MADP acquires the inputs and selections of content and formats from the pharmacist via the GUI 203 and dynamically creates the pharmacist specific CCMA by integrating the selected template objects and the dynamic content objects, for example, a symptom log type, a questionnaire type, content of questions, etc., defined by the pharmacist and assembling the template content and formats. The MADP then performs a quality control test of the pharmacist specific CCMA, in communication with the pharmacist via the GUI 203, to test the sub-applications of the pharmacist specific CCMA. The MADP distributes the pharmacist specific CCMA through multiple distribution options, for example, through application stores, through the pharmacist's website, etc. The pharmacist can download the pharmacist specific CCMA on the pharmacist's electronic device or instruct the patient to download the pharmacist specific CCMA on the patient's electronic device. The patient downloads the pharmacist specific CCMA and during a consultation, the pharmacist can set the pharmacist specific CCMA or instruct the patient to customize the pharmacist specific CCMA to a certain drug or medicine available at the pharmacist's store. The drug information is automatically synchronized to the pharmacist specific CCMA from the pharmacy database. The sub-applications of the pharmacist specific CCMA on the patient's electronic device performs multiple functions, for example, reminds the patient of the number of times for taking the drug, the strength of the drug, and an actual time for taking the drug, checking completion of the actual task, displays key drug information based on linkage to a public database, invokes warnings related to a drug-drug interaction based on backend search of the public database, and displays a web link to the public database for obtaining additional drug information.

Consider another example where a healthcare provider 202 is a clinical researcher and a healthcare recipient 209 is a patient. The mobile application development platform (MADP) enables the clinical researcher to dynamically create a customizable composite mobile application (CCMA). The clinical researcher accesses the MADP by logging into the MADP via the network, for example, the internet. To create the CCMA, the clinical researcher retrieves a template list of template objects comprising multiple sub-applications configured to perform tasks for monitoring the healthcare elements of the patient from the application management database 207 via the graphical user interface (GUI) 203 exemplarily illustrated in FIG. 2. The clinical researcher selects template objects, for example, a question template to define a question, an answer template to define answers, etc., via the GUI 203. In an example, the clinical researcher inputs a test medicine input box such as a drop down selection of medicine and strength, a timer for creating a reminder of medicine administration, a checkbox for finishing the task, a list of questionnaires to survey patients for drug effects and side effects, and summary and report generating formats, via the GUI 203. The MADP acquires the inputs and selections of content and formats from the clinical researcher via the GUI 203 and dynamically creates the clinical researcher specific CCMA by integrating the selected template objects and the dynamic content objects, for example, a symptom log type, a questionnaire type, content of questions, etc., defined by the clinical researcher and assembling the template content and formats. The MADP then performs a quality control test of the clinical researcher specific CCMA, in communication with the clinical researcher via the GUI 203, to test the sub-applications of the clinical researcher specific CCMA. The MADP distributes the clinical researcher specific CCMA through multiple distribution options, for example, through application stores, through an internal website, etc. The clinical researcher can download the clinical researcher specific CCMA on the clinical researcher's electronic device or instruct patients who participate in clinical studies to download the clinical researcher specific CCMA on their electronic devices. The clinical researcher downloads the clinical researcher specific CCMA and during a clinical study, the clinical researcher instructs the patients to customize their clinical researcher specific CCMAs by entering drug taking status, survey results, etc., through their electronic devices. The results are automatically synchronized to the MADP or an external server for clinical researchers to monitor and make real time decisions based on the results. The sub-applications of the clinical researcher specific CCMA on the patients' electronic devices perform multiple functions, for example, reminds the patients of the number of times for taking the drug, the strength of the drug, and an actual time for taking the drug, checking completion of the actual task, invoking a survey for surveying a patient for drug effects and side effects through a questionnaire, generating a summary and reports pertaining to the drug and its effects on the patient, etc.

Consider another example where a healthcare provider 202 is a trainer and a healthcare recipient 209 is a trainee. The mobile application development platform (MADP) enables the trainer to dynamically create a customizable composite mobile application (CCMA). The trainer accesses the MADP by logging into the MADP via the network, for example, the internet. To create the CCMA, the trainer retrieves a template list of template objects comprising multiple sub-applications configured to perform tasks for monitoring of the healthcare elements of the trainee from the application management database 207 via the graphical user interface (GUI) 203 exemplarily illustrated in FIG. 2. The trainer selects template objects, for example, a question template to define a question, an answer template to define answers, etc., via the GUI 203. In an example, the trainer uploads a trainer introduction video clip, uploads a list of video clips demonstrating different exercises such as an exercise for leg pain, a yoga stretch, a physical therapy exercise, etc., via the GUI 203, where each video clip is selectable such that the trainee can select specific video clip to follow, and inserts a check box function for selecting and following the video clips. After the trainer uploads the video clips and format selection, the MADP acquires the uploads and selections of content and formats from the trainer via the GUI 203 and dynamically creates the trainer specific CCMA by integrating the selected template objects and the dynamic content objects, for example, presentation content, etc., defined by the trainer and assembling the template content and formats. The MADP then performs a quality control test of the trainer specific CCMA, in communication with the trainer via the GUI 203, to test the sub-applications of the trainer specific CCMA. The MADP distributes the trainer specific CCMA through multiple distribution options, for example, through application stores, through the trainer's website, etc. The trainer can download the trainer specific CCMA on the trainer's electronic device or instruct the trainee to download the trainer specific CCMA on the trainee's electronic device. The trainee downloads the trainer specific CCMA and during an exercise session, the trainer instructs the trainee to select video clips from the trainer specific CCMA. The trainee selects the appropriate video clips on a graphical user interface (GUI) provided by the trainer specific CCMA and follows the instructions in the video clips to exercise. For example, for leg pain, the trainee selects and follows certain yoga stretches or physical therapy exercise clips. The trainee then clicks on a finish icon on the GUI of the trainer specific CCMA to record the time and date of the exercise after completion of each exercise, and records and communicates comments to the trainer through the trainer specific CCMA. The comments are automatically synchronized to the MADP and accessible by the trainer via the network.

FIGS. 8A-8O exemplarily illustrate screenshots of a graphical user interface (GUI) 203 displaying multiple sub-applications configured to perform tasks for monitoring healthcare elements of a healthcare recipient 209 exemplarily illustrated in FIG. 2. The mobile application development platform (MADP) stores multiple template objects in the application management database 207 as disclosed in the detailed description of FIG. 1. The template objects comprise multiple sub-applications configured to perform tasks for monitoring the healthcare elements. The tasks for monitoring the healthcare elements of the healthcare recipient 209 performed by the sub-applications comprise, for example, generating symptom logs for each of multiple health conditions of the healthcare recipient 209, generating medication reminders configured to manage and record administration of medications by the healthcare recipient 209, generating appointment reminders configured to manage clinical visits of the healthcare recipient 209, generating instructions for a pre-clinic visit and a post-clinic visit by the healthcare recipient 209, and generating demonstrational media content configured to show therapeutical activities, for example, group of short demonstration clips on physical therapy for managing the health conditions of the healthcare recipient 209. The sub-applications are downloadable from an application store, for example, Google Play™ of Google Inc., the App Store™ of Apple Inc., the Windows® Phone Store of Microsoft Corporation, etc.

To generate a healthcare provider specific symptom log for self care or by healthcare provider recommendation, the healthcare provider 202 exemplarily illustrated in FIG. 2, for example, a doctor can download a symptom log, for example, from an application store or from the application management database 207 for creating the customizable composite mobile application (CCMA). FIG. 8A exemplarily illustrates a screenshot of a graphical user interface (GUI) 203 displaying a symptom log with icons used to add a symptom log record, view symptom log data on a calendar, setup a symptom log and a medication reminder, record voice, and select other logs. The healthcare provider 202 can reconfigure the symptom log based on his/her requirements and the healthcare recipient's 209 requirements. FIG. 8B exemplarily illustrates a screenshot of the GUI 203 displaying icons used to add a symptom log record, view symptom log data on a calendar, setup a symptom log and a medication reminder, record voice, and select other logs recommended by the healthcare provider 202. The healthcare recipient 209, for example, a patient downloads the CCMA with the reconfigured symptom log from the application management database 207 via the network. When the healthcare recipient 209 clicks on the “add log record” icon on the GUI provided by the CCMA, the CCMA displays a drop down list of one or more types of symptom logs on the GUI for selection by the healthcare recipient 209. FIG. 8C illustrates a screenshot of the GUI displaying sub-applications, for example, symptom logs available to a patient. The symptom log list comprises, for example, a diabetes blood sugar monitoring log, a gastrointestinal (GI) log, a headache impact test log, a migraine monitoring log, a pain log, a prostate symptom log, etc. The patient selects the GI log and the pain log as exemplarily illustrated in FIG. 8C. The first time a user, for example, the healthcare recipient 209 accesses the CCMA, the number and type of symptom logs in the symptom log list are predetermined. The user can add or remove any items from the symptom log list using the “all logs” icon on the GUI.

In an example, when the patient selects the pain log, the customizable composite mobile application (CCMA) presents questions associated with the pain log to the patient via the GUI of the CCMA as exemplarily illustrated in FIGS. 8D-8I. The CCMA presents the patient with questions, for example, “where is your pain located at? please circle one or more”, and the patient responds to the question by selecting one or more multiple choice answers, for example, neck, lower back, etc., on the GUI of the CCMA as exemplarily illustrated in FIG. 8D. In another example, the CCMA presents the patient with a question “how to rate your average level of pain today on a scale of zero to ten?” and the patient responds to the question by selecting, for example, “4” as the answer on the GUI of the CCMA as exemplarily illustrated in FIG. 8E. In another example, the CCMA presents the patient with a question “circle the words that describe your pain” and the patient responds to the question by selecting, for example, aching, nagging, and sharp as the answer on the GUI of the CCMA as exemplarily illustrated in FIG. 8F. In another example, the CCMA presents the patient with a question “what time of day is your pain the worst?” and the patient responds to the question by selecting, for example, afternoon as the answer on the GUI of the CCMA as exemplarily illustrated in FIG. 8G. In another example, the CCMA presents the patient with a question “what makes your pain worse?” and the patient responds to the question by selecting, for example, resting as the answer on the GUI of the CCMA as exemplarily illustrated in FIG. 8H. In another example, the CCMA presents the patient with a question “what moderate to severe side effect are you having from the medicine you are taking” and the patient responds to the question by selecting, for example, vomiting and constipation as the answer on the GUI of the CCMA as exemplarily illustrated in FIG. 8I. The patient can respond to the questions, for example, by performing a click action, a double click action, a finger tapping action, a touch action, a slide action, a scrolling action, etc., on an interface element such as a check box provided on the GUI of the CCMA, by writing a note, by taking a picture, by recording a video or a voice file, etc.

After the patient has answered all the questions pertaining to the pain log, the CCMA leads the patient to a log review page on the GUI of the CCMA. The patient then reviews, edits answers or choices and saves the changes as exemplarily illustrated in FIG. 8J. The CCMA then leads the patient to a page with a calendar icon, a summary icon, a report icon, and a reminder icon. The calendar icon displays the date and time of creation of the symptom logs, for example, a pain symptom log was created on 18^{th} February 2013 at a time 23:02 as exemplarily illustrated in FIG. 8K. By clicking on a date on the calendar icon, the CCMA directs the patient to the log review page to modify existing answers. The summary icon directs the patient to the most recent summary log page. The “create PDF” interface element on the GUI as exemplarily illustrated in FIG. 8L, generates a portable document format (PDF) report of the summarized logs. The report icon displays options, for example, view report, electronic mail (email) report, schedule report, etc., on the GUI as exemplarily illustrated in FIG. 8M. The patient can view all existing PDF reports, send new reports to his/her doctor or healthcare provider 202, and schedule generation of reports. The reminder icon displays, for example, a symptom log reminder for an asthma assessment, an attention deficit hyperactivity disorder (ADHD) medicine monitoring activity, etc., a medication reminder, and an appointment reminder to the patient with specific instructions as exemplarily illustrated in FIG. 8N. In an example, a reminder pertaining to a pain log is generated and sent to a patient with an electronic mail address “tg201010@gmail.com” and an event time set to “23:00” with specific instructions as exemplarily illustrated in FIG. 8O.

FIG. 9 exemplarily illustrates a screenshot of a graphical user interface (GUI) 203 exemplarily illustrated in FIG. 2, provided by the mobile application development platform (MADP) for dynamically creating the healthcare provider specific customizable composite mobile application (CCMA). A healthcare provider 202 exemplarily illustrated in FIG. 2, for example, a doctor can create a new symptom log or edit an existing symptom log, for example, a chronic pain monitoring log by clicking on the “My Logs” icon on the GUI 203 for creating the CCMA. While creating a symptom log, the doctor enters a name for the symptom log on the GUI 203. The name for the symptom log can be based on a symptom if there is no existing symptom log with the same name or based on the doctor's choice. The GUI 203 lists the newly created symptom log along with the existing symptom logs available for editing. While editing the symptom logs, the doctor chooses the question type, and then enters the detailed question and the answer choice. For example, if the doctor chooses to edit the question “how to rate your average level of pain on a scale of zero to ten”, the doctor enters the question in the field “enter question details below” and edits the question. Similarly, the doctor may also edit an answer for the question on the GUI 203 as exemplarily illustrated in FIG. 9.

FIGS. 10A-10H exemplarily illustrate screenshots of a graphical user interface (GUI) 203 exemplarily illustrated in FIG. 2, provided by the mobile application development platform (MADP), displaying format templates for different question types. The format templates for questions comprise options, for example, a radio choice question, a multiple choice question, a pain scale question, a scale question, a value entry question, a picture choice question, a multiple entry question, a multiple choice question with a dropdown, etc. FIG. 10A exemplarily illustrates a radio choice question format template configured for questions. The radio choice question format template for questions displays answers with radio choices. For example, if the MADP presents a question such as “Over the last two weeks, how often have you been bothered by any of the following problems? little interest or pleasure in doing things” on the GUI 203 exemplarily illustrated in FIG. 2, the MADP displays radio choice answers such as “Not at all”, “Several days”, “More than half the days”, “Nearly every day”, etc., on the GUI 203 as exemplarily illustrated in FIG. 10A.

FIG. 10B exemplarily illustrates a multiple choice question format template configured for questions. The multiple choice question format template for questions displays answers with multiple choices. For example, if the MADP presents a question such as “medications you are taking” on the GUI 203, the MADP displays multiple choice answers such as “Adderall”, “Addrall XR”, “Atomaxetine”, etc., on the GUI 203 as exemplarily illustrated in FIG. 10B. FIG. 10C exemplarily illustrates a pain scale question format template configured for questions. The pain scale question format template enables the patient to choose an answer choice on a sliding scale corresponding to a scale value and severity of the symptom. For example, if the MADP presents a question such as “How to rate your average level of pain today on a scale of zero to ten?” on the GUI 203, the MADP displays pain scale answers based on a scale value, for example, 0-10, corresponding to the severity of the symptom, for example, “No Pain”, “Mild”, “Moderate”, “Severe”, etc., on the GUI 203 as exemplarily illustrated in FIG. 10C.

FIG. 10D exemplarily illustrates a scale question format template configured for questions. The scale question format template enables the patient to choose an answer choice on a sliding scale corresponding to a scale value. For example, if the MADP presents a question such as “Rate the overall quality of the night sleep?” on the GUI 203, the MADP displays pain scale answers based on a scale value, for example, 0-10 as exemplarily illustrated in FIG. 10D. FIG. 10E exemplarily illustrates a value entry question format template configured for questions that require a patient to enter a value. The value entry question format template allows the patient to enter a value as an answer for a question. For example, if the MADP presents a question such as “How many times calling out in the class” on the GUI 203, the enter value option allows the patient to enter a value as an answer as exemplarily illustrated in FIG. 10E.

FIG. 10F exemplarily illustrates a picture choice question format template configured for questions. The picture choice question format template allows the patient to select a location on a picture as an answer for a question. For example, if the MADP presents a question such as “Where is your pain location?”, on the GUI 203, the picture choice option allows the patient to select a location on the picture as an answer as exemplarily illustrated in FIG. 10F. FIG. 10G exemplarily illustrates a multiple entry question format template configured for questions. The multiple entry question format template for questions allows the patient to enter answers for a multiple entry question. For example, if the MADP presents a question such as “Please enter congestive heart failure (CHF) monitoring values?”, on the GUI 203, the multiple entry question format allows the patient to enter answers for multiple entry questions, for example, “weight”, “Systolic BP”, “Diastolic BP”, heart rate, etc., as exemplarily illustrated in FIG. 10G.

FIG. 10H exemplarily illustrates a multiple choice question format template with a dropdown configured for questions. The multiple choice question format template with the dropdown allows the patient to select answers from a dropdown list for multiple choice questions. For example, if the MADP presents a question such as “Please describe how pain interferes with your life today”, on the GUI 203, the multiple choice question format template with the dropdown allows the patient to select answers from a dropdown list, for example, “General activity”, “Mood”, “Normal work”, etc., as exemplarily illustrated in FIG. 10H.

FIGS. 11A-11B exemplarily illustrate screenshots of a graphical user interface (GUI) 203 exemplarily illustrated in FIG. 2, provided by the mobile application development platform (MADP), displaying format templates for different answer types. Based on the selected format template for different question types as disclosed in the detailed description of FIGS. 10A-10H, the healthcare provider 202 exemplarily illustrated in FIG. 2 enters answer choices on the GUI 203. For example, the doctor enters answer choices for a question in fields provided on the GUI 203 as exemplarily illustrated in FIG. 11A. In another example, for a picture choice question, the doctor enters an answer choice by clicking on a location in an image or a picture, which causes that location to be highlighted and “x” and “y” coordinates relative to the top left corner of the image on the X axis and Y axis fields to be shown on the GUI 203. The X axis and Y axis fields are configured as read only fields. After the doctor clicks on an add icon on the GUI 203, the highlighted locations change to a numeral and the “x” and “y” coordinates of the highlighted locations are added to a location list as exemplarily illustrated in FIG. 11B.

FIG. 12 exemplarily illustrates a screenshot of a graphical user interface (GUI) 203 exemplarily illustrated in FIG. 2, provided by the mobile application development platform (MADP), displaying a format template for generating reports associated with healthcare elements of a healthcare recipient 209 exemplarily illustrated in FIG. 2. In addition to defining the format templates for questions and answers as disclosed in the detailed description of FIGS. 10A-11B, a healthcare provider 202 exemplarily illustrated in FIG. 2, for example, a doctor can also define a format template for a report. A healthcare provider 202, for example, a doctor can create a new symptom log or edit an existing symptom log, for example, a cancer log, a pain log, etc., by clicking on the “My Logs” icon for creating the customizable composite mobile application (CCMA) as disclosed in the detailed description of FIG. 9. The doctor selects a format template for a report of the symptom logs, for example, a depression log, vital sign monitoring data, etc., and selects questions using the selected format template of the report exemplarily illustrated in FIG. 12.

FIGS. 13A-13E exemplarily illustrate screenshots of a graphical user interface (GUI) 203 exemplarily illustrated in FIG. 2, provided by the mobile application development platform (MADP), displaying multiple report formats used in generation of reports associated with healthcare elements of a healthcare recipient 209 exemplarily illustrated in FIG. 2. The report formats comprise, for example, a timeline chart, a horizontal table, a description format, a pie chart, and a vertical table. FIG. 13A exemplarily illustrates a screenshot of a report format in the form of a timeline chart. A report of, for example, a depression log of a healthcare recipient 209 can be represented in a timeline chart labeled with dates, for example, “12/23”, “12/25”, etc., and corresponding depression score ratings as exemplarily illustrated in FIG. 13A. FIG. 13B exemplarily illustrates a screenshot of a report format configured in the form of a horizontal table. In an example, a vital sign monitoring log comprising monitoring data of vital signs such as systolic blood pressure (BP), diastolic BP, heart rate, temperature, etc., of a healthcare recipient 209 can be represented in a table form labeled with dates, for example, “12/29” and corresponding vital sign values as exemplarily illustrated in FIG. 13B.

FIG. 13C exemplarily illustrates a screenshot of a report in a description format. A report of, for example, a shortness breath log associated with healthcare elements, for example, shortness of breath, feelings, etc., of a healthcare recipient 209 is represented in a description format labeled with dates, for example, “12/21/2012”, “12/21/2012”, etc., and corresponding descriptions as exemplarily illustrated in FIG. 13C. FIG. 13D exemplarily illustrates a screenshot of a report in the form of a pie chart. A report of, for example, a pain log associated with pain levels of a healthcare recipient 209 can be represented in a pie chart with multiple pain levels, for example, “Pain level 1-2”, “Pain level 3-4”, etc., as exemplarily illustrated in FIG. 13D. FIG. 13E illustrates a screenshot of a report in the form of a vertical table. A report of, for example, an asthma log associated with asthma related events such as “The time asthma keeps you from getting work done”, “Rate of asthma”, “Time you use a rescue inhaler” etc., of a healthcare recipient 209 is represented in a vertical table labeled with dates, for example, “12/29” as exemplarily illustrated in FIG. 13E.

FIGS. 14A-14C exemplarily illustrate screenshots of a graphical user interface (GUI) 203 exemplarily illustrated in FIG. 2, provided by the mobile application development platform (MADP), for generating reminders and instructions for a pre-clinic visit and a post-clinic visit. FIG. 14A exemplarily illustrates a screenshot of the GUI 203 for configuring reminders. The MADP enables a healthcare provider 202 exemplarily illustrated in FIG. 2, for example, a doctor to select a sub-application that generates reminders for monitoring healthcare elements of a healthcare recipient 209 exemplarily illustrated in FIG. 2 via the GUI 203. The reminders are, for example, medication reminders, appointment reminders, etc. The medication reminders inform the patient to take medication at a set date and time and record the completion of such compliance through the customizable composite mobile application (CCMA). The CCMA allows a healthcare recipient 209, for example, a patient to input multiple medication names, multiple time points to be reminded for taking medication, checker functions to ensure completion of medications, and generate summary and reports of such compliance. The reminder functions comprise, for example, options to electronic mail (email), text or call a healthcare provider 202 informing him/her of any changes made by the healthcare recipient 209. The appointment reminders inform the healthcare recipient 209, for example, a patient of an upcoming appointment at a clinic. The reminders are set based on a schedule, for example, from “2012-11-14” to “2012-11-30” for medication consumption, an event time, for example, “05:33:00”, etc. The reminders can be set to repeat after a particular time interval elapses, for example, after a 3-day interval as exemplarily illustrated in FIG. 14A.

FIGS. 14B-14C exemplarily illustrate screenshots of the graphical user interface (GUI) 203 exemplarily illustrated in FIG. 2, provided by the mobile application development platform (MADP), displaying instructions for a pre-clinic visit and a post-clinic visit. The mobile application development platform (MADP) enables a healthcare provider 202 exemplarily illustrated in FIG. 2, for example, a doctor to generate instructions, for example, a checklist or a task list for a pre-clinic visit and a post-clinic visit for monitoring healthcare elements of a healthcare recipient 209 exemplarily illustrated in FIG. 2, for example, a patient. FIG. 14B exemplarily illustrates a list of existing checklists, for example, a procedure instruction, a checklist 2, a checklist 3, a checklist 4, etc., stored in the application management database 207 exemplarily illustrated in FIG. 2 by the MADP. The healthcare provider 202 can select a check list from the existing checklists, for example, a procedure instruction or create a new checklist via the GUI 203 for monitoring the healthcare elements of the patient. FIG. 14C exemplarily illustrates content of a checklist defined by a healthcare provider 202, for example, a doctor. The content of a checklist comprises instructions defined by a doctor, for example, “Medication you need to take before dinner reminder time 17:57”, “No food before the procedure reminder time 6:57”, etc. The doctor can also set a reminder notification for each of the instructions and a checker function to record the completion of the generated instructions via the GUI 203. The reminder notification prompts the patient to take action on the instructions. The doctor can edit the content of the checklist via the GUI 203 prior to sending the instructions to the patient.

FIG. 15 exemplarily illustrates a screenshot of a graphical user interface (GUI) 203 exemplarily illustrated in FIG. 2, provided by the mobile application development platform (MADP) for patients. In an embodiment, the mobile application development platform (MADP) is configured as a web based platform for dynamically creating the customizable composite mobile application (CCMA). The healthcare recipient 209 exemplarily illustrated in FIG. 2, for example, a patient and the healthcare provider 202 exemplarily illustrated in FIG. 2, for example, a doctor use the web based platform to view patient's reports, for example, a symptom log report. The report can be in multiple formats, for example, a pie chart based report, a timeline chart based report, a multiple timeline chart based report, a description format based report, and a table format based report as disclosed in the detailed description of FIGS. 13A-13E. FIG. 15 exemplarily illustrates a timeline chart based report for a pain log in a graphical format and a pie chart based report. The timeline chart shows a graph indicating severity of different pains, for example, “Pain 1”, “Pain 2”, “Pain 3”, etc., over a period of time, for example, “January”, “February”, “March”, etc.

FIG. 16 exemplarily illustrates a computer implemented system 1600 for dynamically creating a healthcare provider specific customizable composite mobile application (CCMA) 1603 and monitoring healthcare elements of a healthcare recipient 209 exemplarily illustrated in FIG. 2, using the CCMA 1603. The computer implemented system 1600 disclosed herein comprises a mobile application development platform (MADP) 1601 accessible by a healthcare provider device 1608 and a healthcare recipient device 208, for example, a mobile phone, a laptop, a tablet computing device, etc., via a network 1607 as disclosed in the detailed description of FIGS. 1-2.

The mobile application development platform (MADP) 1601 comprises at least one processor and a non-transitory computer readable storage medium communicatively coupled to the processor. The non-transitory computer readable storage medium is configured to store modules 206, 210, 1602, 1604, 1605, 1606, etc., of the MADP 1601. The MADP 1601 further comprises an application management database 207 configured to store multiple template objects and the customizable composite mobile application (CCMA) 1603 dynamically created by the mobile application creation module 206 of the MADP 1601 as disclosed in the detailed description of FIGS. 1-2. In an embodiment, the application management database 207 also stores the dynamic content objects acquired from the healthcare provider device 1608. The application management database 207 is accessible by the healthcare recipient device 208 via the network 1607 for utilization of the dynamically created CCMA 1603.

The mobile application development platform (MADP) 1601 comprises modules 206, 210, 1602, 1604, 1605, 1606, etc., executable by at least one processor configured to configured to facilitate the dynamic creation of the customizable composite mobile application (CCMA) 1603. The modules of the MADP 1601 comprise a graphical user interface (GUI) 203, a data acquisition module 1602, the mobile application creation module 206, and a communication module 210. The data acquisition module 1602 is configured to define the template objects or retrieve the template objects from multiple sources. The data acquisition module 1602 is further configured to acquire one or more dynamic content objects defined by a healthcare provider 202 exemplarily illustrated in FIG. 2, via the GUI 203 provided by the MADP 1601. The data acquisition module 1602 is further configured to acquire a selection of one or more template objects and the acquired dynamic content objects from the healthcare provider device 1608 via the GUI 203. The mobile application creation module 206 is configured to dynamically create the CCMA 1603 by integrating the template objects and the acquired dynamic content objects based on the acquired selection. The communication module 210 is configured to facilitate communication between the healthcare provider device 1608 and the healthcare recipient device 208 through the dynamically created CCMA 1603 via the application management database 207 and the network 1607 for monitoring the healthcare elements of the healthcare recipient 209. The communication module 210 of the mobile application development platform (MADP) 1601 is configured to transmit notifications to the healthcare recipient device 208 via the network 1607. The notifications comprise instructions defined by the healthcare provider 202 via the GUI 203 of the MADP 1601 based on the acquired healthcare recipient data.

The dynamically created customizable composite mobile application (CCMA) 1603 comprises one or more sub-applications, for example, 1603a, 1603b, 1603c, and 1603d executable by at least one processor configured to monitor and communicate the healthcare elements of the healthcare recipient 209. The sub-applications, for example, 1603a, 1603b, 1603c, and 1603d of the dynamically created CCMA 1603 are configured to execute tasks for monitoring the healthcare elements of the healthcare recipient 209. The sub-applications of the dynamically created CCMA 1603 comprise, for example, a log generation sub-application 1603a, a reminder generation sub-application 1603b, an instruction generation sub-application 1603c, and a content generation sub-application 1603d. The log generation sub-application 1603a is configured to generate one or more symptom logs for each of the health conditions of the healthcare recipient 209. The reminder generation sub-application 1603b is configured to generate medication reminders. The medication reminders are configured to manage and record administration of medications by the healthcare recipient 209. The reminder generation sub-application 1603b is further configured to generate appointment reminders. The appointment reminders are configured to manage clinical visits of the healthcare recipient 209. The instruction generation sub-application 1603c is configured to generate instructions for a pre-clinic visit and a post-clinic visit for the healthcare recipient 209. The content generation sub-application 1603d is configured to generate demonstrational media content. The demonstrational media content is configured to show therapeutical activities for managing the health conditions of the healthcare recipient 209.

The mobile application development platform (MADP) 1601 further comprises an updation module 1605 and a delivery module 1604. The updation module 1605 is configured to dynamically update the template objects in the application management database 207 based on improvement criteria and changes acquired from one or more healthcare provider devices 1608 and one or more healthcare recipient devices 208 via the network 1607. The delivery module 1604 is configured to download the dynamically created customizable composite mobile application (CCMA) 1603 on the healthcare recipient device 208 from the application management database 207 via the network 1607. The dynamically created customizable composite mobile application (CCMA) 1603 further comprises a rendering module 1603e, a recording module 1603f, and a summarization module 1603g executable by at least one processor on the healthcare recipient device 208. The rendering module 1603e is configured to render the selected template objects and the acquired dynamic content objects to the healthcare recipient device 208 via one or more communication modes, for example, a voice mode, a text mode, an image mode, an audio mode, a video mode, a multimedia mode, etc., and any combination thereof. The recording module 1603f is configured to record responses to the selected template objects and the acquired dynamic content objects from the healthcare recipient 209 via one or more of the communication modes. The summarization module 1603g is configured to summarize results generated by each of the sub-applications, for example, 1603a, 1603b, 1603c, and 1603d onto one or more display interfaces, for example, a calendar interface, a report interface, etc., for interconnecting one or more of the sub-applications, for example, 1603a, 1603b, 1603c, and 1603d. The data acquisition module 1602 of the MADP 1601 is further configured to acquire healthcare recipient data comprising a selection of one or more of the sub-applications, for example, 1603a, 1603b, 1603c, and 1603d from the selected template objects for customizing the dynamically created CCMA 1603. The healthcare recipient data comprises, for example, one or more of textual data, voice data, image data, audio data, video data, multimedia data, etc., and any combination thereof. The updation module 1605 of the MADP 1601 is further configured to update the dynamically created CCMA 1603 based on the acquired healthcare recipient data. The delivery module 1604 of the MADP 1601 is further configured to deliver the updated customized dynamically created CCMA 1603 to the healthcare recipient device 208 via the application management database 207 and the network 1607. The MADP 1601 further comprises a report generation module 1606 configured to generate reports based on changes in the template objects.

FIG. 17 exemplarily illustrates the architecture of a computer system 1700 employed by the mobile application development platform (MADP) 1601 and a healthcare recipient device 208 exemplarily illustrated in FIG. 16, for dynamically creating a healthcare provider specific customizable composite mobile application (CCMA) 1603 and monitoring healthcare elements of a healthcare recipient 209 using the CCMA 1603. The MADP 1601 of the computer implemented system 1600 exemplarily illustrated in FIG. 16 employs the architecture of the computer system 1700 exemplarily illustrated in FIG. 17. The healthcare recipient device 208 exemplarily illustrated in FIG. 2 and FIG. 16 also employs the architecture of the computer system 1700 exemplarily illustrated in FIG. 17. The computer system 1700 is programmable using a high-level computer programming language. The computer system 1700 may be implemented using specially-programmed, special purpose hardware. The mobile application development platform (MADP) 1601 communicates with the healthcare provider device 1608 and the healthcare recipient device 208 via a network 1607, for example, a short range network or a long range network. The network 1607 is, for example, the internet, a local area network, a wide area network, a wired network, a wireless network, a mobile communication network, etc.

The computer system 1700 comprises, for example, a processor 1701, a memory unit 1702 for storing programs and data, an input/output (I/O) controller 1703, a network interface 1704, a data bus 1705, a display unit 1706, input devices 1707, a fixed media drive 1708, a removable media drive 1709 for receiving removable media, output devices 1710, etc. The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1701 may also be implemented as a processor set comprising, for example, a general purpose microprocessor and a math or graphics co-processor. The processor 1701 is selected, for example, from the Intel® processors such as the Itanium® microprocessor or the Pentium® processors, Advanced Micro Devices (AMD®) processors such as the Athlon® processor, UltraSPARC® processors, microSPARC™ processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The computer implemented system 1600 disclosed herein is not limited to a computer system 1700 employing a processor 1701. The computer system 1700 may also employ a controller or a microcontroller.

The memory unit 1702 is used for storing programs, applications, and data. For example, the data acquisition module 1602, the mobile application creation module 206, the communication module 210, the updation module 1605, the delivery module 1604, the report generation module 1606, etc., of the mobile application development platform (MADP) 1601 are stored in the memory unit 1702 of the MADP 1601. The memory unit 1702 is, for example, a random access memory (RAM) or another type of dynamic storage device that stores information and instructions for execution by the processor 1701. The memory unit 1702 also stores temporary variables and other intermediate information used during execution of the instructions by the processor 1701. The computer system 1700 further comprises a read only memory (ROM) or another type of static storage device that stores static information and instructions for the processor 1701.

The network interface 1704 enables connection of the computer system 1700 to the network 1607. For example, the mobile application development platform (MADP) 1601 connects to the network 1607 via the network interface 1704. In another example, the healthcare recipient device 208 connects to the network 1607 via the network interface 1704. In an embodiment, the network interface 1704 is provided as an interface card also referred to as a line card. The network interface 1704 comprises, for example, one or more of an infrared (IR) interface, an interface implementing WiFi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high-speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 1703 controls input actions and output actions performed by the mobile application development platform 1601. The data bus 1705 permits communications between the modules, for example, 206, 210, 1604, 1602, 1604, 1605, 1606, etc., of the MADP 1601. The data bus 1705 also permits communication between the modules, for example, 1603e, 1603f, and 1603g and sub-applications, for example, 1603a, 1603b, 1603c, 1603d, etc., of the customizable composite mobile application (CCMA) 1603.

The display unit 1706 of the mobile application development platform (MADP) 1601, for example, via the graphical user interface (GUI) 203, displays information, display interfaces, user interface elements such as text fields, checkboxes, text boxes, windows, etc., for acquiring one or more dynamic content objects defined by a healthcare provider 202 exemplarily illustrated in FIG. 2, acquiring a selection of one or more template objects and the acquired dynamic content objects from the healthcare provider device 1608, etc. The display unit 1706 comprises, for example, a liquid crystal display, a plasma display, an organic light emitting diode (OLED) based display, etc. The input devices 1707 are used for inputting data into the computer system 1700. For example, a healthcare recipient 209 selects one or more template objects and one or more dynamic content objects defined by the healthcare provider 202, using the input devices 1707 of the healthcare recipient device 208. The input devices 1707 are, for example, a keyboard such as an alphanumeric keyboard, a joystick, a pointing device such as a computer mouse, a touch pad, a light pen, a physical button, a pointing device, a touch sensitive display device, a track ball, a pointing stick, any device capable of sensing a tactile input, etc.

Computer applications and programs are used for operating the computer system 1700. The programs are loaded onto the fixed media drive 1708 and into the memory unit 1702 of the computer system 1700 via the removable media drive 1709. The fixed media drive 1708 is also used for storing programs, applications, and data. For example, the log generation sub-application 1603a, the reminder generation sub-application 1603b, the instruction generation sub-application 1603c, the content generation sub-application 1603d, the rendering module 1603e, the recording module 1603f, and the summarization module 1603g of the customizable composite mobile application (CCMA) 1603 are stored in the fixed media drive 1708 of the healthcare recipient device 208. In an embodiment, the computer applications and programs may be loaded directly via the network 1607. Computer applications and programs are executed by double clicking a related icon displayed on the display unit 1706 using one of the input devices 1707. The output devices 1710 output the results of operations performed by the mobile application development platform (MADP) 1601 and the healthcare recipient device 208.

The processor 1701 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 1700 employs the operating system for performing multiple tasks. The operating system is responsible for management and coordination of activities and sharing of resources of the computer system 1700. The operating system further manages security of the computer system 1700, peripheral devices connected to the computer system 1700, and network connections. The operating system employed on the computer system 1700 recognizes, for example, inputs provided by the users using one of the input devices 1707, the output display, files, and directories stored locally on the fixed media drive 1708, for example, a hard drive. The operating system on the computer system 1700 executes different programs using the processor 1701. The processor 1701 and the operating system together define a computer platform for which application programs in high level programming languages are written.

The processor 1701 of the mobile application development platform (MADP) 1601 retrieves instructions for executing the modules, for example, 206, 210, 1602, 1604, 1605, 1606, etc., of the MADP 1601, from the memory unit 1702 of the MADP 1601. The processor 1701 of the healthcare recipient device 208 retrieves instructions for executing the modules, for example, 1603e, 1603f, and 1603g and sub-applications, for example, 1603a, 1603b, 1603c, 1603d, etc., of the customizable composite mobile application (CCMA) 1603, from the fixed media drive 1708 of the healthcare recipient device 208. A program counter determines the location of the instructions in the memory unit 1702 and the fixed media drive 1708. The program counter stores a number that identifies the current position in the program of each of the modules, for example, 206, 210, 1602, 1604, 1605, 1606, etc., of the MADP 1601 and the modules, for example, 1603e, 1603f, and 1603g and sub-applications, for example, 1603a, 1603b, 1603c, 1603d, etc., of the CCMA 1603. The instructions fetched by the processor 1701 from the memory unit 1702 and the fixed media drive 1708 after being processed are decoded. The instructions are stored in an instruction register in the processor 1701.

After processing and decoding, the processor 1701 executes the instructions. For example, the data acquisition module 1602 defines instructions for defining the template objects and/or retrieving the template objects from multiple sources. The data acquisition module 1602 also defines instructions for acquiring one or more dynamic content objects defined by a healthcare provider 202 via the graphical user interface (GUI) 203 provided by the mobile application development platform (MADP) 1601. Furthermore, the data acquisition module 1602 defines instructions for acquiring a selection of one or more template objects and the acquired dynamic content objects from the healthcare provider device 1608 via the GUI 203. The mobile application creation module 206 defines instructions for dynamically creating the CCMA 1603 by integrating the template objects and the acquired dynamic content objects based on the acquired selection. The communication module 210 defines instructions for facilitating communication between the healthcare provider device 1608 and the healthcare recipient device 208 through the dynamically created CCMA 1603 via the application management database 207 and the network 1607 for monitoring the healthcare elements of the healthcare recipient 209.

The dynamically created customizable composite mobile application (CCMA) 1603 comprising one or more sub-applications 1603a, 1603b, 1603c, 1603d, etc., defines instructions for monitoring and communicating the healthcare elements of the healthcare recipient 209. The sub-applications 1603a, 1603b, 1603c, 1603d, etc., of the dynamically created CCMA 1603 define instructions for executing tasks for monitoring the healthcare elements of the healthcare recipient 209. For example, the log generation sub-application 1603a defines instructions for generating one or more symptom logs for each of the health conditions of the healthcare recipient 209. The reminder generation sub-application 1603b defines instructions for generating medication reminders configured to manage and record administration of medications by the healthcare recipient 209. Furthermore, the reminder generation sub-application 1603b defines instructions for generating appointment reminders configured to manage clinical visits of the healthcare recipient 209. The instruction generation sub-application 1603c defines instructions for generating instructions for a pre-clinic visit and a post-clinic visit for the healthcare recipient 209. The content generation sub-application 1603d defines instructions for generating demonstrational media content configured to show therapeutical activities for managing the health conditions of the healthcare recipient 209.

The delivery module 1604 of the mobile application development platform (MADP) 1601 defines instructions for downloading the dynamically created customizable composite mobile application (CCMA) 1603 on the healthcare recipient device 208 from the application management database 207 via the network 1607. The updation module 1605 defines instructions for dynamically updating the template objects in the application management database 207 based on improvement criteria and changes acquired from one or more healthcare provider devices 1608 and one or more healthcare recipient devices 208 via the network 1607. Furthermore, the rendering module 1603e of the dynamically created CCMA 1603 defines instructions for rendering the selected template objects and the acquired dynamic content objects to the healthcare recipient device 208 via one or more of multiple communication modes. The recording module 1603f defines instructions for recording responses to the selected template objects and the acquired dynamic content objects from the healthcare recipient 209 via the communication modes. The summarization module 1603g defines instructions for summarizing results generated by each of the sub-applications 1603a, 1603b, 1603c, 1603d, etc., onto one or more display interfaces for interconnecting one or more of the sub-applications 1603a, 1603b, 1603c, 1603d, etc.

Furthermore, the data acquisition module 1602 of the mobile application development platform (MADP) 1601 defines instructions for acquiring healthcare recipient data comprising a selection of one or more of the sub-applications, for example, 1603a, 1603b, 1603c, and 1603d from the template objects via the GUI 203 for customizing the dynamically created CCMA 1603. Furthermore, the updation module 1605 defines instructions for updating the dynamically created CCMA 1603 based on the acquired healthcare recipient data. Furthermore, the delivery module 1604 defines instructions for delivering the updated dynamically created CCMA 1603 to the healthcare recipient device 208 via the application management database 207 and the network 1607. The communication module 210 defines instructions for transmitting notifications to the healthcare recipient device 208 via the network 1607. The report generation module 1606 defines instructions for generating reports based on changes in the template objects.

The processor 1701 of the mobile application development platform (MADP) 1601 retrieves the instructions defined by the data acquisition module 1602, the mobile application creation module 206, the communication module 210, the updation module 1605, the delivery module 1604, and the report generation module 1606, and executes the instructions, thereby performing one or more processes defined by those instructions. The processor 1701 of the healthcare recipient device 208 retrieves the instructions defined by the log generation sub-application 1603a, the reminder generation sub-application 1603b, the instruction generation sub-application 1603c, the content generation sub-application 1603d, the rendering module 1603e, the recording module 1603f, and the summarization module 1603g, and executes the instructions, thereby performing one or more processes defined by those instructions.

At the time of execution, the instructions stored in the instruction register are examined to determine the operations to be performed. The processor 1701 then performs the specified operations. The operations comprise arithmetic operations and logic operations. The operating system performs multiple routines for performing a number of tasks required to assign the input devices 1707, the output devices 1710, and memory for execution of the modules, for example, 206, 210, 1602, 1604, 1605, 1606, etc., of the mobile application development platform (MADP) 1601 and the modules, for example, 1603e, 1603f, 1603g and sub-applications, for example, 1603a, 1603b, 1603c, 1603d, etc., of the customizable composite mobile application (CCMA) 1603. The tasks performed by the operating system comprise, for example, assigning memory to the modules, for example, 206, 210, 1602, 1604, 1605, 1606, etc., of the MADP 1601 and the modules, for example, 1603e, 1603f, and 1603g and sub-applications, for example, 1603a, 1603b, 1603c, 1603d, etc., of the CCMA 1603, moving data between the memory unit 1702, the fixed media drive 1708 and disk units, and handling input/output operations. The operating system performs the tasks on request by the operations and after performing the tasks, the operating system transfers the execution control back to the processor 1701. The processor 1701 continues the execution to obtain one or more outputs. The outputs of the execution of the modules, for example, 206, 210, 1602, 1604, 1605, 1606, etc., of the MADP 1601 are displayed on the display unit 1706 to a user, for example, the healthcare provider 202 or the service administrator 201 exemplarily illustrated in FIG. 2. The outputs of the execution of the modules, for example, 1603e, 1603f, and 1603g and the sub-applications, for example, 1603a, 1603b, 1603c, 1603d, etc., of the CCMA 1603 are also displayed on the display unit 1706 to the user, for example, the healthcare recipient 209.

For purposes of illustration, the detailed description refers to the mobile application development platform (MADP) 1601 being run locally on a computer system 1700; however the scope of the computer implemented method and system 1600 disclosed herein is not limited to the MADP 1601 being run locally on the computer system 1700 via the operating system and the processor 1701, but may be extended to run remotely over the network 1607 by employing a web browser and a remote server, a mobile phone, or other electronic devices. One or more portions of the computer system 1700 may be distributed across one or more computer systems (not shown) coupled to the network 1607.

Disclosed herein is also a computer program product comprising a non-transitory computer readable storage medium that stores computer program codes comprising instructions executable by at least one processor 1701 for dynamically creating a healthcare provider specific customizable composite mobile application (CCMA) 1603 and monitoring healthcare elements of a healthcare recipient 209 using the CCMA 1603. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 1701, except for a transitory, propagating signal.

The computer program codes comprise a first computer program code for storing multiple template objects in the application management database 207; a second computer program code for acquiring one or more dynamic content objects defined by a healthcare provider 202 via the graphical user interface (GUI) 203; a third computer program code for acquiring a selection of one or more template objects and the acquired dynamic content objects from the healthcare provider device 1608 via the GUI 203; a fourth computer program code for dynamically creating a customizable composite mobile application (CCMA) 1603 by integrating the template objects and the acquired dynamic content objects based on the acquired selection; a fifth computer program code for storing the dynamically created CCMA 1603 in the application management database 207; and a sixth computer program code for facilitating communication between the healthcare provider device 1608 and the healthcare recipient device 208 through the dynamically created CCMA 1603 via the application management database 207 and the network 1607 for monitoring the healthcare elements of the healthcare recipient 209.

The computer program product disclosed herein further comprises one or more additional computer program codes for performing additional steps that may be required and contemplated for dynamically creating a healthcare provider specific customizable composite mobile application (CCMA) 1603 and monitoring healthcare elements of a healthcare recipient 209 using the CCMA 1603. In an embodiment, a single piece of computer program code comprising computer executable instructions performs one or more steps of the computer implemented method disclosed herein for dynamically creating the CCMA 1603 and monitoring healthcare elements of the healthcare recipient 209 using the CCMA 1603. The computer program codes comprising computer executable instructions are embodied on the non-transitory computer readable storage medium. The processor 1701 of the computer system 1700 retrieves these computer executable instructions and executes them. When the computer executable instructions are executed by the processor 1701, the computer executable instructions cause the processor 1701 to perform the steps of the computer implemented method for dynamically creating the CCMA 1603 and monitoring healthcare elements of a healthcare recipient 209 using the CCMA 1603.

FIG. 18 exemplarily illustrates a network architecture 1800 employed by the mobile application development platform (MADP) 1601 for dynamically creating a healthcare provider specific customizable composite mobile application (CCMA) 1603 exemplarily illustrated in FIG. 16, and monitoring healthcare elements of a healthcare recipient 209 exemplarily illustrated in FIG. 2, using the CCMA 1603. The MADP 1601 is hosted on a web hosting network. The network architecture 1800 of the MADP 1601 comprises a wireless access point 1801 and a web server 1804 and network interface controllers 1803a and 1803b positioned between firewalls 1802a and 1802b. The healthcare provider device 1608, for example, a doctor's device and a healthcare recipient device 208, for example, a patient's device access the MADP 1601 via the network 1607 exemplarily illustrated in FIG. 16, for example, the internet. The healthcare provider device 1608 and the healthcare recipient device 208 wirelessly access the web server 1804 that hosts the MADP 1601 through the wireless access point 1801. The web server 1804 by default listens, for example, to port 80 during a hypertext transfer protocol (HTTP) session. A first firewall 1802a is positioned at a network gateway of the web server 1804 and a second firewall 1802b is positioned at a network gateway of the web hosting network. The firewalls 1802a and 1802b provide secure access of the MADP 1601 to the healthcare provider device 1608 and the healthcare recipient device 208. The network interface controllers 1803a and 1803b connect the healthcare provider device 1608 and the healthcare recipient device 208 to the network 1607. The web hosting network maintains the application management database 207 that stores multiple template objects comprising format templates and multiple sub-applications, for example, 1603a, 1603b, 1603c, and 1603d exemplarily illustrated in FIG. 16, configured to perform tasks for monitoring the healthcare elements of the healthcare recipient 209. In an embodiment, the application management database 207 is configured on a virtual server.

FIG. 19 exemplarily illustrates a software architecture 1900 employed by the mobile application development platform (MADP) 1601 exemplarily illustrated in FIG. 16, for dynamically creating a healthcare provider specific customizable composite mobile application (CCMA) 1603 and monitoring healthcare elements of a healthcare recipient 209 exemplarily illustrated in FIG. 2, using the CCMA 1603 accessed via the application management database 207. FIG. 19 also shows response flows through the software architecture 1900 employed by the MADP 1601. The web server 1804 comprising, for example, a web application apache server 1805 is accessible by the healthcare provider device 1608, for example, a doctor's device and the healthcare recipient device 208, for example, a patient's device, via an external firewall. A representational state transfer (REST) architecture is used in designing web services for the MADP 1601. The healthcare provider device 1608 via a web browser application 1901 accesses the web server 1804. A RESTful client service 1902 in the web browser application 1901 sends a hypertext transfer protocol (HTTP) request to a dynamic web page service 1805b of the web server 1804 via port 80. The dynamic web page service 1805b of the web server 1804 sends an HTTP response to the web browser application 1901. The RESTful client service 1902 in the web browser application 1901 also sends a RESTful HTTP request to a RESTful server service 1805a of the web server 1804 via port 80. The healthcare recipient device 208 sends a RESTful HTTP request to the RESTful server service 1805a of the web server 1804, while the RESTful server service 1805a sends a RESTful HTTP response to the healthcare recipient device 208 via an HTTP protocol. A real time notification service 601 of the web server 1804 sends notifications to the healthcare recipient device 208 via a user datagram protocol (UDP).

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, hypertext preprocessor (PHP), Objective-C® of Apple Inc., JavaScript®, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the application management database 207, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, Hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for dynamically creating a healthcare provider specific customizable composite mobile application and monitoring healthcare elements of a healthcare recipient using said customizable composite mobile application, said computer implemented method comprising:
providing a mobile application development platform comprising at least one processor configured to facilitate said dynamic creation of said customizable composite mobile application, wherein said mobile application development platform is accessible by a healthcare provider device and a healthcare recipient device via a network;
storing a plurality of template objects by said mobile application development platform in an application management database, wherein said template objects comprise a plurality of sub-applications configured to perform tasks for said monitoring of said healthcare elements of said healthcare recipient;
acquiring one or more dynamic content objects defined by a healthcare provider via a graphical user interface provided by said mobile application development platform;
acquiring a selection of one or more of said template objects and said acquired one or more dynamic content objects from said healthcare provider device by said mobile application development platform via said graphical user interface;
dynamically creating said customizable composite mobile application by said mobile application development platform by integrating said one or more of said template objects and said acquired one or more dynamic content objects based on said acquired selection, wherein said mobile application development platform is configured to store said dynamically created customizable composite mobile application in said application management database, and wherein said application management database is accessible by said healthcare recipient device via said network for utilization of said dynamically created customizable composite mobile application; and
facilitating communication between said healthcare provider device and said healthcare recipient device through said dynamically created customizable composite mobile application via said application management database and said network for said monitoring of said healthcare elements of said healthcare recipient.

2. The computer implemented method of claim 1, wherein said tasks for said monitoring of said healthcare elements of said healthcare recipient performed by said sub-applications comprise one or more of:
generating one or more symptom logs for each of a plurality of health conditions of said healthcare recipient;
generating medication reminders configured to manage and record administration of medications by said healthcare recipient;
generating appointment reminders configured to manage clinical visits of said healthcare recipient;
generating instructions for a pre-clinic visit and a post-clinic visit for said healthcare recipient; and
generating demonstrational media content configured to show therapeutical activities for managing said health conditions of said healthcare recipient.

3. The computer implemented method of claim 1, wherein said selection of said one or more of said template objects comprises a selection of one or more of content for each of said sub-applications configured to execute said tasks on said healthcare recipient device and a format template for each of said sub-applications.

4. The computer implemented method of claim 1, wherein said template objects are one of defined by said mobile application development platform and retrieved from a plurality of sources by said mobile application development platform.

5. The computer implemented method of claim 1, wherein said healthcare elements comprise symptoms, physiological parameters, medication compliance, healthcare compliance, pre-visit preparations of said healthcare recipient, post visit follow ups of said healthcare recipient, and healthcare activities performed by said healthcare recipient.

6. The computer implemented method of claim 1, wherein said template objects further comprise format templates configured for questions, answers, instructions, reports, data analysis, and summarization of results associated with said healthcare elements of said healthcare recipient.

7. The computer implemented method of claim 1, wherein said one or more dynamic content objects comprise one or more of a symptom log type, a questionnaire type, content of questions, content of answers, presentation formats, presentation content, healthcare provider specific information, instructions from said healthcare provider, display preferences of said healthcare provider, and any combination thereof.

8. The computer implemented method of claim 1, further comprising rendering said one or more of said template objects and said acquired one or more dynamic content objects to said healthcare recipient device by said dynamically created customizable composite mobile application via one or more of a plurality of communication modes, wherein said communication modes comprise a voice mode, a text mode, an image mode, an audio mode, a video mode, a multimedia mode, and any combination thereof.

9. The computer implemented method of claim 1, further comprising recording responses to said one or more of said template objects and said acquired one or more dynamic content objects from said healthcare recipient by said dynamically created customizable composite mobile application via one or more of a plurality of communication modes, wherein said communication modes comprise a voice mode, a text mode, an image mode, an audio mode, a video mode, a multimedia mode, and any combination thereof.

10. The computer implemented method of claim 1, further comprising dynamically updating said template objects in said application management database by said mobile application development platform based on improvement criteria and changes acquired from one or more healthcare provider devices and one or more healthcare recipient devices via said network.

11. The computer implemented method of claim 1, further comprising summarizing results generated by each of said sub-applications onto one or more display interfaces by said dynamically created customizable composite mobile application for interconnecting one or more of said sub-applications, wherein said display interfaces comprise a calendar interface and a report interface.

12. The computer implemented method of claim 1, wherein said dynamically created customizable composite mobile application is configured as a software application downloadable on said healthcare recipient device.

13. The computer implemented method of claim 1, further comprising:
downloading said dynamically created customizable composite mobile application on said healthcare recipient device from said application management database via said network;
acquiring healthcare recipient data comprising a selection of one or more of said sub-applications from said one or more of said template objects by said mobile application development platform via said graphical user interface for customizing said dynamically created customizable composite mobile application;
updating said dynamically created customizable composite mobile application based on said acquired healthcare recipient data by said mobile application development platform; and
delivering said updated dynamically created customizable composite mobile application to said healthcare recipient device by said mobile application development platform via said application management database and said network.

14. The computer implemented method of claim 13, wherein said healthcare recipient data comprises one or more of textual data, voice data, image data, audio data, video data, multimedia data, and any combination thereof.

15. The computer implemented method of claim 13, further comprising transmitting notifications to said healthcare recipient device by said mobile application development platform via said network, wherein said notifications comprise instructions defined by said healthcare provider via said graphical user interface of said mobile application development platform based on said acquired healthcare recipient data.

16. The computer implemented method of claim 1, further comprising generating reports by said mobile application development platform based on changes in said template objects.

17. A computer implemented system for dynamically creating a healthcare provider specific customizable composite mobile application and monitoring healthcare elements of a healthcare recipient using said customizable composite mobile application, said computer implemented system comprising:
a mobile application development platform accessible by a healthcare provider device and a healthcare recipient device via a network, said mobile application development platform comprising:
at least one processor;
a non-transitory computer readable storage medium communicatively coupled to said at least one processor, said non-transitory computer readable storage medium configured to store modules of said mobile application development platform;
an application management database configured to store a plurality of template objects and said customizable composite mobile application dynamically created by a mobile application creation module of said mobile application development platform, wherein said template objects comprise a plurality of sub-applications configured to perform tasks for said monitoring of said healthcare elements of said healthcare recipient, and wherein said application management database is accessible by said healthcare recipient device via said network for utilization of said dynamically created customizable composite mobile application;
said modules of said mobile application development platform, comprising:
a data acquisition module configured to acquire one or more dynamic content objects defined by a healthcare provider via a graphical user interface provided by said mobile application development platform;
said data acquisition module configured to acquire a selection of one or more of said template objects and said acquired one or more dynamic content objects from said healthcare provider device via said graphical user interface;
said mobile application creation module configured to dynamically create said customizable composite mobile application by integrating said one or more of said template objects and said acquired one or more dynamic content objects based on said acquired selection; and
a communication module configured to facilitate communication between said healthcare provider device and said healthcare recipient device through said dynamically created customizable composite mobile application via said application management database and said network for said monitoring of said healthcare elements of said healthcare recipient; and
said dynamically created customizable composite mobile application comprising one or more of said sub-applications executable by at least one processor configured to monitor and communicate said healthcare elements of said healthcare recipient.

18. The computer implemented system of claim 17, wherein said one or more of said sub-applications of said dynamically created customizable composite mobile application are configured to execute said tasks for said monitoring of said healthcare elements of said healthcare recipient, said sub-applications comprising one or more of:
a log generation sub-application configured to generate one or more symptom logs for each of a plurality of health conditions of said healthcare recipient;
a reminder generation sub-application configured to generate medication reminders, said medication reminders configured to manage and record administration of medications by said healthcare recipient;
said reminder generation sub-application configured to generate appointment reminders, said appointment reminders configured to manage clinical visits of said healthcare recipient;
an instruction generation sub-application configured to generate instructions for a pre-clinic visit and a post-clinic visit for said healthcare recipient; and
a content generation sub-application configured to generate demonstrational media content, said demonstrational media content configured to show therapeutical activities for managing said health conditions of said healthcare recipient.

19. The computer implemented system of claim 17, wherein said data acquisition module of said mobile application development platform is configured to one of define said template objects and retrieve said template objects from a plurality of sources.

20. The computer implemented system of claim 17, wherein said healthcare elements comprise symptoms, physiological parameters, medication compliance, healthcare compliance, pre-visit preparations of said healthcare recipient, post visit follow ups of said healthcare recipient, and healthcare activities performed by said healthcare recipient.

21. The computer implemented system of claim 17, wherein said template objects further comprise format templates configured for questions, answers, instructions, reports, data analysis, and summarization of results associated with said healthcare elements of said healthcare recipient.

22. The computer implemented system of claim 17, wherein said one or more dynamic content objects comprise one or more of a symptom log type, a questionnaire type, content of questions, content of answers, presentation formats, presentation content, healthcare provider specific information, instructions from said healthcare provider, display preferences of said healthcare provider, and any combination thereof.

23. The computer implemented system of claim 17, wherein said dynamically created customizable composite mobile application further comprises a rendering module executable by at least one processor, wherein said rendering module is configured to render said one or more of said template objects and said acquired one or more dynamic content objects to said healthcare recipient device via one or more of a plurality of communication modes, wherein said communication modes comprise a voice mode, a text mode, an image mode, an audio mode, a video mode, a multimedia mode, and any combination thereof.

24. The computer implemented system of claim 17, wherein said dynamically created customizable composite mobile application further comprises a recording module executable by at least one processor, wherein said recording module is configured to record responses to said one or more of said template objects and said acquired one or more dynamic content objects from said healthcare recipient via one or more of a plurality of communication modes, wherein said communication modes comprise a voice mode, a text mode, an image mode, an audio mode, a video mode, a multimedia mode, and any combination thereof.

25. The computer implemented system of claim 17, wherein said modules of said mobile application development platform further comprise an updation module configured to dynamically update said template objects in said application management database based on improvement criteria and changes acquired from one or more healthcare provider devices and one or more healthcare recipient devices via said network.

26. The computer implemented system of claim 17, wherein said dynamically created customizable composite mobile application further comprises a summarization module executable by at least one processor, wherein said summarization module is configured to summarize results generated by each of said sub-applications onto one or more display interfaces for interconnecting one or more of said sub-applications, wherein said display interfaces comprise a calendar interface and a report interface.

27. The computer implemented system of claim 17, wherein said dynamically created customizable composite mobile application is configured as a software application downloadable on said healthcare recipient device.

28. The computer implemented system of claim 17, wherein said modules of said mobile application development platform further comprise:
a delivery module configured to download said dynamically created customizable composite mobile application on said healthcare recipient device from said application management database via said network;
said data acquisition module configured to acquire healthcare recipient data comprising a selection of one or more of said sub-applications from said one or more of said template objects via said graphical user interface for customizing said dynamically created customizable composite mobile application;
an updation module configured to update said dynamically created customizable composite mobile application based on said acquired healthcare recipient data; and
said delivery module configured to deliver said updated dynamically created customizable composite mobile application to said healthcare recipient device via said application management database and said network.

29. The computer implemented system of claim 28, wherein said healthcare recipient data comprises one or more of textual data, voice data, image data, audio data, video data, multimedia data, and any combination thereof.

30. The computer implemented system of claim 28, wherein said communication module of said mobile application development platform is configured to transmit notifications to said healthcare recipient device via said network, wherein said notifications comprise instructions defined by said healthcare provider via said graphical user interface of said mobile application development platform based on said acquired healthcare recipient data.

31. The computer implemented system of claim 17, wherein said modules of said mobile application development platform further comprise a report generation module configured to generate reports based on changes in said template objects.

32. A computer program product comprising a non-transitory computer readable storage medium, said non-transitory computer readable storage medium storing computer program codes that comprise instructions executable by at least one processor, said computer program codes comprising:
a first computer program code for storing a plurality of template objects in an application management database, wherein said template objects comprise a plurality of sub-applications configured to perform tasks for monitoring healthcare elements of a healthcare recipient;
a second computer program code for acquiring one or more dynamic content objects defined by a healthcare provider via a graphical user interface;
a third computer program code for acquiring a selection of one or more of said template objects and said acquired one or more dynamic content objects from a healthcare provider device via said graphical user interface;
a fourth computer program code for dynamically creating a customizable composite mobile application by integrating said one or more of said template objects and said acquired one or more dynamic content objects based on said acquired selection;
a fifth computer program code for storing said dynamically created customizable composite mobile application in said application management database, wherein said application management database is accessible by a healthcare recipient device via a network for utilization of said dynamically created customizable composite mobile application; and
a sixth computer program code for facilitating communication between said healthcare provider device and said healthcare recipient device through said dynamically created customizable composite mobile application via said application management database and said network for said monitoring of said healthcare elements of said healthcare recipient.
